(19) United States
(12) Patent Application Publication
(10) Pub. No.: US 2012/0140072 A1
(43) Pub. Date: Jun. 7, 2012

(54) OBJECT DETECTION APPARATUS

(75) Inventors: Kimitaka MURASHITA, Kobe-shi (JP); Tetsuo YAMAMOTO, Kobe-shi (JP)

(73) Assignee: FUJITSU TEN LIMITED, Kobe-shi (JP)

(21) Appl. No.: 13/298,782

(22) Filed: Nov. 17, 2011

(30) Foreign Application Priority Data
Dec. 6, 2010 (JP) 2010-271740

(51) Int. Cl. G06K 9/00; H04N 7/18

(52) U.S. Cl. 348/148; 382/103; 348/E07.085

(57) ABSTRACT

A parameter memory of an object detection apparatus retains a plurality of parameters used for a detection process for each of a plurality of detection conditions. A parameter selector selects a parameter from amongst the parameters retained in the parameter memory, according to an existing detection condition. Then an object detector performs the detection process of detecting an object approaching a vehicle, based on a captured image captured by a camera out of a plurality of cameras disposed at different locations of the vehicle, by using the parameter selected by the parameter selector.

### BACKGROUND OF THE INVENTION

1. Field of the Invention

The invention relates to a technology that detects an object in a vicinity of a vehicle.

2. Description of the Background Art

An obstacle detection apparatus for a vehicle has been conventionally proposed. For example, a conventional obstacle detection apparatus includes: a left camera and a right camera that are provided respectively on a left side and a right side of a vehicle, facing forward from the vehicle, and that capture images of areas at a long distance; and a center camera that is provided between the left and the right cameras to capture images of a wide area at a short distance. The obstacle detection apparatus includes: a left A/D converter; a right A/D converter; and a center A/D converter; each of which receives outputs from the left, the right and the center cameras; and a matching apparatus that receives outputs from the left and the right A/D converters, matches an object on both images, and outputs parallax between the left and the right images. Moreover, the obstacle detection apparatus includes: a distance computer that receives an output from the matching apparatus and detects an obstacle by outputting a distance using trigonometry; and a previous-image comparison apparatus that receives an output from the center A/D converter and detects the object of which movement on the images is different from a supposed movement caused by travel of the vehicle; and a display that receives the outputs from distance computer and the previous-image comparison apparatus and displays the obstacle.

Moreover, a laterally-back monitoring apparatus for a vehicle has been conventionally proposed. For example, a conventional laterally-back monitoring apparatus selects one from amongst a camera disposed on a rear side, a camera disposed on a right side mirror, a camera disposed on a left side mirror of a vehicle (host vehicle) by changing a switch of a switch box according to a position of a turn signal switch. The laterally-back monitoring apparatus performs image processing of image data output from the camera selected and detects a vehicle that is too close to the host vehicle.

Moreover, a distance distribution detection apparatus has been conventionally proposed. For example, a conventional distance distribution detection apparatus computes distance distribution of a target object of which images are captured, by analyzing the images captured from different multiple spatial viewing locations. In addition, the distance distribution detection apparatus checks a partial image that becomes a unit of analysis of the image, and select a level of spatial resolution of a distance direction or of a parallax angle direction, required for computing the distance distribution, according to a distance range to which the partial image is estimated to belong.

In a case of detecting an object that makes a specific movement relative to the vehicle, based on an image captured by a camera disposed on the vehicle, detection capability differs according to detection conditions such as a location of the object, a relative moving direction of the object, and a location of the camera disposed on the vehicle. Hereinafter, an example in which an object approaching a vehicle is detected based on an optical flow is described.

FIG. 1 illustrates an outline of an optical flow. A detection process is performed on an image P. The image P shows a traffic light 90 at the back and a vehicle 91 traveling. In the detection process using the optical flow, feature points of the image are extracted first. The feature points are indicated by cross marks “x” on the image P.

Then displacements of the feature points for a predetermined time period Δt are detected. For example, when the host vehicle is stopping, the feature points detected on the traffic light 90 have not moved and positions of the feature points detected on the vehicle 91 have moved according to a traveling direction and a speed of the vehicle 91. A vector indicating the movements of the feature points is called the “optical flow.” In a case of an example shown in FIG. 1, the feature points have moved to a left direction on the image P.

Next, it is determined, based on a direction and a size of the optical flow of an object, whether or not the object on the image P makes a specific movement relative to the vehicle. For example, in a case of the example shown in FIG. 1, it is determined that the vehicle 91 of which optical flow is in the left direction as an approaching object, and the object is detected.

FIG. 2 illustrates a range in which a moving object in a vicinity of a vehicle 2 is detected. The vehicle 2 shown in FIG. 2 includes multiple cameras (concretely, a front camera, a right-side camera, and a left-side camera) disposed at locations different from each other. An angle θ 11 is an angle of view of the front camera, and a range A1 and a range A2 indicate ranges in which an approaching object S can be detected based on a captured image captured by the front camera.

An angle θ 12 is an angle of view of the left-side camera, and a range A3 indicates a range in which the approaching object S can be detected based on a captured image captured by the left-side camera. An angle θ 13 is an angle of view of the right-side camera, and a range A4 indicates a range in which the approaching object S can be detected based on a captured image captured by the right-side camera.

FIG. 3A illustrates a captured image PF captured by the front camera. A region R1 and a region R2 on the captured image RF captured by the front camera are detection ranges respectively showing the range A1 and the range A2 shown in FIG. 2. Moreover, FIG. 3B illustrates a captured image PL captured by the left-side camera. A region R3 on the captured image PL captured by the left-side camera is a detection range showing the range A3 shown in FIG. 2.

In the following description, the captured image captured by the front camera may be referred to as “front camera image,” a captured image captured by the right-side camera may be referred to as “right camera image,” and the captured image captured by the left-side camera may be referred to as “left camera image.”

As shown in the drawing, in the detection range R1 on a left side of the front camera image PF, the approaching object S moves from an image end portion to an image center portion. In other words, an optical flow of the object S detected in the detection range R1 is in a direction from the image end portion to the image center portion. Similarly, in the detection range R2 on a right side of the front camera image PF, an optical flow of an approaching object is in a direction from the image end portion to the image center portion.

On the other hand, in the detection range R3 on a right side of the left camera image PL, the approaching object S moves from the image center portion to the image end portion. In other words, the optical flow of the object S detected in the detection range R3 moves from the image center portion to the image end portion. As described above, the optical flow direction of the object S on the front camera image PF differs from the optical flow direction of the object S on the left camera image PL. When the object S appears on the front camera image PF, the optical flow of the object S moves toward the image center portion, and when the object S appears on the left camera image PL, the optical flow of the object moves toward the image end portion.

In the aforementioned description, an object “approaching” the vehicle is described as an example of an object that makes a specific movement relative to the vehicle. However, a similar phenomenon occurs also in a case of detecting an object making a different movement. In other words, even if an object makes a consistent movement relative to the vehicle, there is a case where the optical flow direction of the object differs among the captured images, captured by multiple cameras, on which the object appears.

Therefore, when an object making a specific movement relative to the vehicle is detected, if an optical flow direction is determined as a direction to be detected by all the multiple cameras, there may be a case where a camera, out of the multiple cameras, disposed at a location can detect the object but another camera, out of the multiple cameras, disposed at another location cannot detect the object although the object is one and the same object.

Moreover, an obstacle in the vicinity of the vehicle may cause difference in detection capability among the multiple cameras. FIG. 4 illustrates difference in fields of view (FOV) between the front camera and a side camera. In FIG. 4, an obstacle Ob is located on a right side of the vehicle 2. In addition, a range 93 is a range of front FOV of the front camera and a range 94 is a range of a right-frontward FOV of the right-side camera.

As shown in the drawing, since a part of the FOV of the right-side camera is blocked by the obstacle Ob, a right-front range that the right-side camera can scan is narrower than a range that the front camera can scan. As a result, when the captured image captured by the right-side camera is used, an object at a long distance cannot be detected. On the other hand, the front camera provided on a front end of the vehicle has a wider FOV than the side camera. As a result, it is easier to detect an object at a long distance by using the captured image captured by the front camera.

Moreover, the speed of the vehicle may change capability of detecting an object. FIG. 5 illustrates a change in capability of detecting the object due to the speed of the vehicle. A camera 111 and a camera 112 are respectively the front camera and the right-side camera both provided on the vehicle 2.

An object 95 and an object 96 are relatively approaching the vehicle 2. A course 97 and a course 98 indicated by arrows respectively show expected courses of the objects 95 and 96 approaching the vehicle 2.

When traveling forward, a driver has a greater duty of care for looking forward than a duty of care for looking backward or sideward. Therefore, an object expected to pass in front of the vehicle 2 is regarded more important than an object expected to pass behind the vehicle 2 when the object approaching the vehicle 2 is detected.

In a case of detecting an object approaching the vehicle 2 from ahead of the vehicle 2 on the right, using the optical flow of the object, when the object passes by a left side of a place where the camera is provided, an optical flow direction of the object is the same as an optical flow direction of an object passing in front of the vehicle 2. In other words, the optical flow moving from the image end portion toward the image center portion is detected. On the other hand, when the object passes by a right side of a place where the camera is provided, an optical flow direction of the object is opposite to an object passing across in front of the vehicle 2. In other words, the optical flow moving from the image center portion toward the image end portion is detected. It is determined that the object having an optical flow direction from the image center portion toward the image end portion is moving away from the vehicle 2.

In an example shown in FIG. 5, based on the captured image captured by the front camera 111, the object 95 approaching from ahead of the vehicle 2 on the right side on the course 97 leading to a collision with the vehicle 2 on a left-front side, can be detected. However, the object 96 approaching from ahead of the vehicle 2 on the right side on the course 98 leading to a collision with the vehicle 2 on a right-front side, cannot be detected because the optical flow direction of the object 96 indicates that the object 96 is moving away from the vehicle 2.

If the speed of the vehicle 2 is accelerated, the course on which the object 95 approaches changes from the course 97 to a course 99. In this case, the object 95 approaches the vehicle 2 on a course leading to a collision with the vehicle 2 on the right-front side. As a result, as is the case in the object 96 approaching on the course 98, the object 95 cannot be detected based on the captured image capture by the front camera 111. When the speed of the vehicle 2 is accelerated, there is a higher possibility that an object in a right-front direction of the vehicle collides with the vehicle 2 on the right-front side and there is a lower possibility that the object collides with the vehicle 2 on the left-front side.

On the other hand, based on the captured image captured by the right-side camera 112, the optical flow direction of the object approaching the vehicle 2 on a course leading to a collision with the vehicle 2 on the right-front side is the same as the optical flow direction of the object approaching the vehicle 2 on a course leading to a collision with the vehicle 2 on the left-front side, because the object passes by the left side of the right-side camera 112. Therefore, even if the speed of the vehicle 2 is accelerated and there is a higher possibility that the object in a right-front of the vehicle 2 collides with the vehicle 2 on the right-front side, the object can be detected, in many cases, based on the captured image captured by the right-side camera 112 similarly to a case where the vehicle is stopped.

As described above, the speed of the vehicle may cause difference in detection capability among the multiple cameras. Moreover, the speed of the object may affect on the detection capability among the multiple cameras.

As described above, when an object making a specific movement relative to a vehicle is detected based on a captured image captured by a camera, the detection capability may vary depending on each of detection conditions such as a position of the object, a relative moving direction of the object, position of a camera provided on the vehicle, relative speed of the object and the vehicle.

Therefore, even when multiple cameras are provided in order to improve detection accuracy, there is a possibility that an object to be detected can be detected based on captured images captured by one of multiple cameras but cannot be detected based on captured images captured by the other cameras on a specific detection condition. On the specific detection condition, if a malfunction occurs to a detection process based on the capture image captured by the camera capable to detect the object, the object may not be detectable based on the captured images captured by all the multiple cameras. In addition, on a detection condition, the object to be detected may not be detectable in the detection process based on captured images captured by all the multiple cameras.

### SUMMARY OF THE INVENTION

According to one aspect of the invention, an object detection apparatus that detects an object in a vicinity of a vehicle includes: a memory that retains a plurality of parameters used for a detection process of detecting an object making a specific movement relative to the vehicle, for each of a plurality of detection conditions; a parameter selector that selects a parameter from amongst the parameters retained in the memory, according to an existing detection condition; and an object detector that performs the detection process, using the parameter selected by the parameter selector, based on a captured image captured by a camera out of a plurality of cameras disposed at different locations of the vehicle.

The parameters for each of the plurality of detection conditions are prepared, and object detection is performed by using a parameter out of the parameters, according to an existing detection condition. Therefore, since the object detection can be performed by using the parameter appropriate to the existing detection condition, detection accuracy in detecting an object making a specific movement relative to the vehicle can be improved.

According to another aspect of the invention, the parameter selector selects the parameter based on the camera which obtains the captured image that the object detector uses for the detection process.

Since the object detection can be performed by using the parameter appropriate to the camera which obtains the captured image, the detection accuracy in detecting an object can be further improved.

Therefore, the object of the invention is to improve detection accuracy in detecting an object making a specific movement relative to a vehicle, based on captured images captured by a plurality of cameras disposed at different locations of the vehicle.

These and other objects, features, aspects and advantages of the invention will become more apparent from the following detailed description of the invention when taken in conjunction with the accompanying drawings.

### BRIEF DESCRIPTION OF THE DRAWINGS

FIG. 1 illustrates an outline of an optical flow;

FIG. 2 illustrates a range in which an object is detected;

FIG. 3A illustrates a front camera image;

FIG. 3B illustrates a left camera image;

FIG. 4 illustrates difference in field of view between the front camera and a side camera;

FIG. 5 illustrates a change in detection capability due to speed;

FIG. 6 is a block diagram illustrating a first configuration example of an object detection system;

FIG. 7 illustrates an example of disposition of multiple cameras;

FIG. 8A illustrates detection ranges on a front camera image;

FIG. 8B illustrates a detection range on a left camera image;

FIG. 9A illustrates a situation where a vehicle leaves a parking space;

FIG. 9B illustrates a detection range on a front camera image;

FIG. 9C illustrates a detection range on a left camera image;

FIG. 9D illustrates a detection range on a right camera image;

FIG. 10A illustrates a situation where a vehicle changes lanes;

FIG. 10B illustrates a detection range on a right camera image;

FIG. 11 illustrates an example of a process performed by the object detection system in the first configuration example;

FIG. 12 is a block diagram illustrating a second configuration example of the object detection system;

FIG. 13 is a block diagram illustrating a third configuration example of the object detection system;

FIG. 14 illustrates an example displayed on a display of a navigation apparatus;

FIG. 15A illustrates a situation where a vehicle turns to the right on a narrow street;

FIG. 15B illustrates a detection range on a front camera image;

FIG. 15C illustrates a detection range on a right camera image;

FIG. 16A illustrates a situation where a vehicle leaves a parking space;

FIG. 16B illustrates a detection range on a front camera image;

FIG. 16C illustrates a detection range on a left camera image;

FIG. 16D illustrates a detection range on a right camera image;

FIG. 17A illustrates a situation where a vehicle changes lanes;

FIG. 17B illustrates a detection range on a right camera image;

FIG. 18 illustrates a first example of a process performed by the object detection system in the third configuration example;

FIG. 19 illustrates a second example of a process performed by the object detection system in the third configuration example;

FIG. 20 is a block diagram illustrating a fourth configuration example of the object detection system;

FIG. 21 is a block diagram illustrating a fifth configuration example of the object detection system;

FIG. 22 illustrates an example of a process performed by the object detection system in the fifth configuration example;

FIG. 23 is a block diagram illustrating a sixth configuration example of the object detection system;

FIG. 24A illustrates an example of obstacles;

FIG. 24B illustrates an example of obstacles;

FIG. 25 illustrates an example of a process performed by the object detection system in the sixth configuration example;

FIG. 26 is a block diagram illustrating a seventh configuration example of the object detection system;

FIG. 27A illustrates an example of a process performed by the object detection system in the seventh configuration example;

FIG. 27B illustrates choice examples of parameters;

FIG. 28 is a block diagram illustrating an eighth configuration example of the object detection system;

FIG. 29 illustrates a first example of a process performed by the object detection system in the eighth configuration example;

FIG. 30 illustrates a second example of a process performed by the object detection system in the eighth configuration example; and

FIG. 31 illustrates an informing method of a detection result.

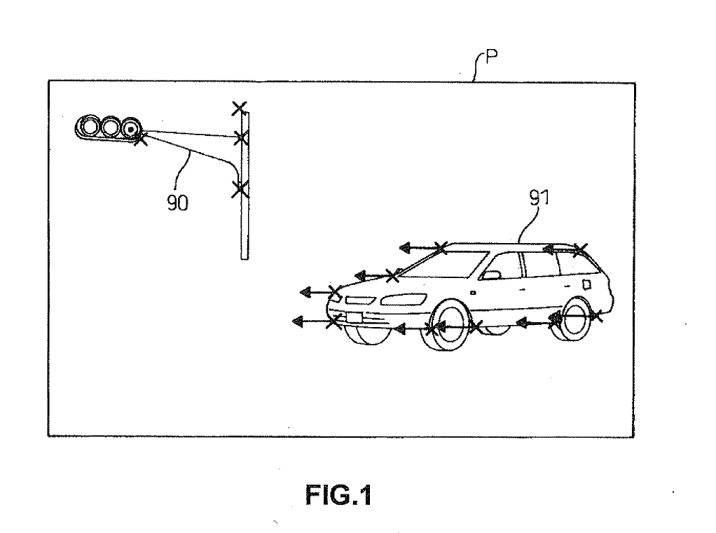

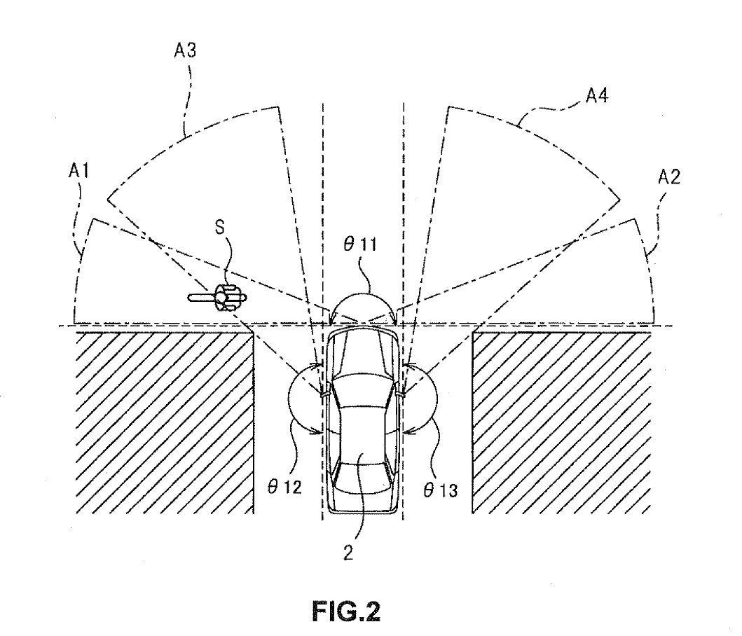

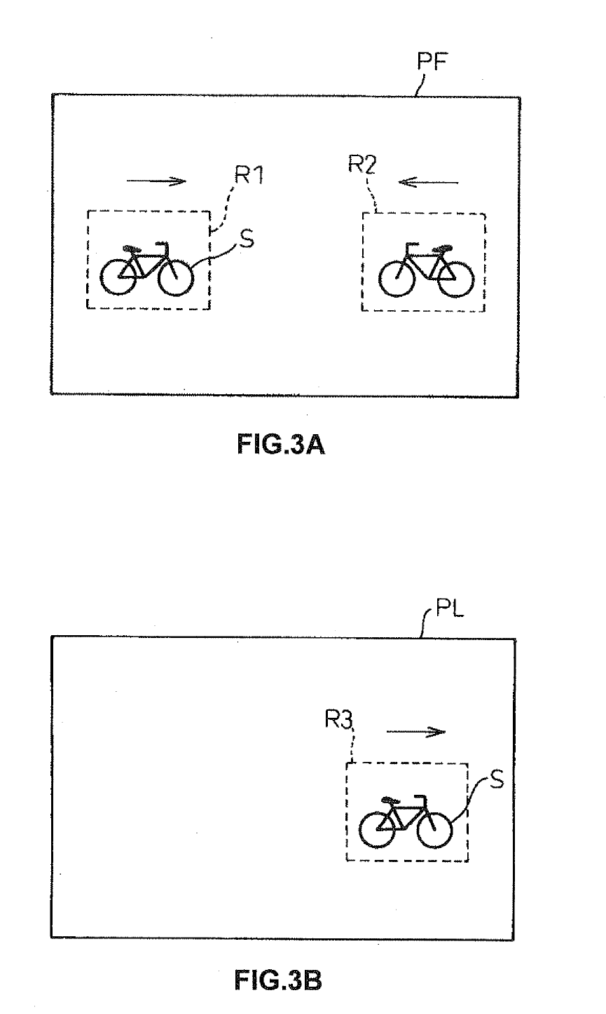

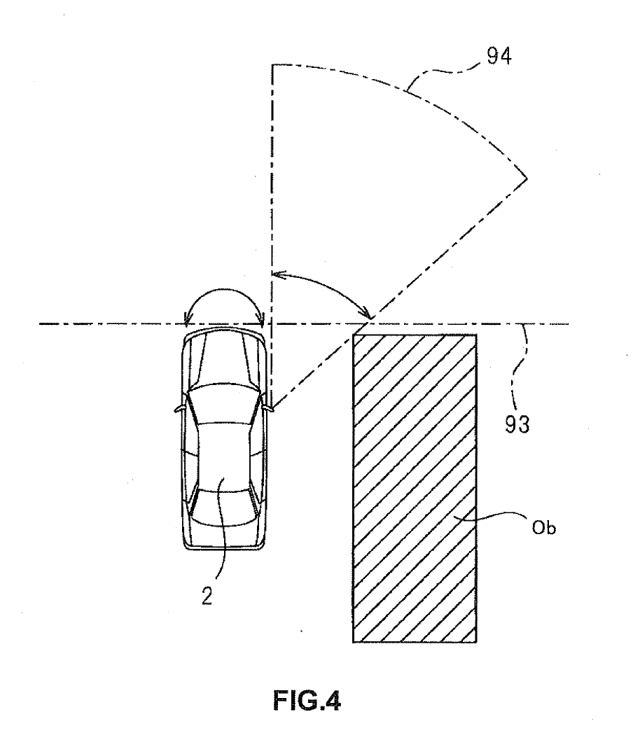

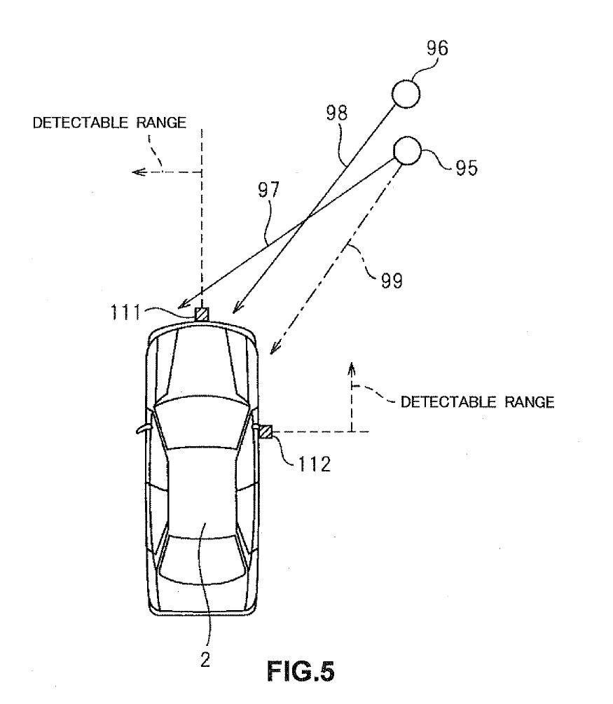

### DESCRIPTION OF THE EMBODIMENTS

Hereinafter, embodiments of the invention are described, referring to the drawings.

### 1. First Embodiment>

### 1-1. System Configuration

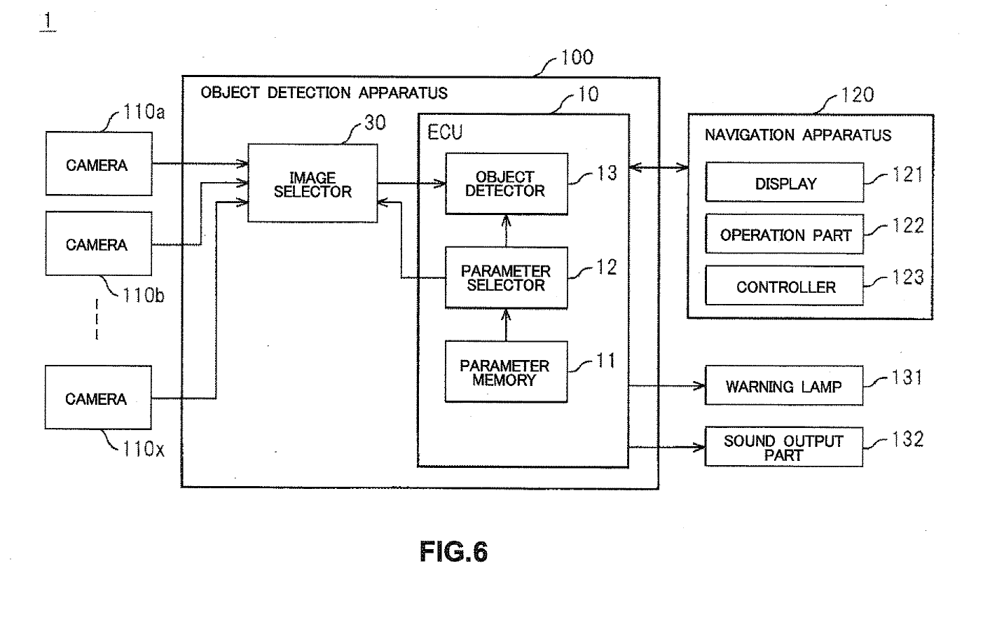

FIG. 6 is a block diagram illustrating a first configuration example of an object detection system 1. The object detection system 1 is installed on a vehicle (a car in this embodiment) and includes a function of detecting an object making a specific movement relative to the vehicle based on images captured by cameras disposed respectively at multiple locations on the vehicle. The object detection system 1 includes a function of detecting an object approaching relatively to the vehicle. However, the technology described below can be applied to a function of detecting an object making another specific movement relative to the vehicle.

As shown in FIG. 6, the object detection system 1 includes an object detection apparatus 100 that detects an object approaching the vehicle based on a captured image captured by a camera, multiple cameras 100a to 100x that are disposed separately from each other on the vehicle, a navigation apparatus 120, a warning lamp 131, and a sound output part 132.

A user can operate the object detection apparatus 100 via the navigation apparatus 120. Moreover, the user is notified of a detection result detected by the object detection apparatus 100 via a human machine interface (HMI), such as a display 121 of the navigation apparatus 120, the warning lamp 131, and the sound output part 132. The warning lamp 131 is, for example, a LED warning lamp. Moreover, the sound output part 132 is, for example, a speaker or an electronic circuit that generates a sound signal or a voice signal and that outputs the signal to a speaker. Hereinafter the human machine interface is also referred to as “HMI.”

The display 121 displays, for example, the detection result detected by the object detection apparatus 100 along with the captured image captured by a camera of the multiple cameras 100a to 100x or displays a warning screen according to the result detected. For example, the user may be informed of the detection result by blinking of the warning lamp 131 disposed in front of a driver seat. Moreover, for example, the user may be informed of the detection result by a voice or a beep sound output from the navigation apparatus 120.

The navigation apparatus 120 provides a navigation guide to the user. The navigation apparatus 120 includes the display 121, such as a liquid crystal display including a touch-panel function, an operation part 122 having, for example, a hardware switch for a user operation, a controller 123 that controls the entire apparatus.

The navigation apparatus 120 is disposed, for example, on an instrument panel of the vehicle such that the user can see a screen of the display 121. Each of commands from the user is received by the operation part 122 or the display 121 serving as a touch panel. The controller 123 includes a computer having a CPU, a RAM, a ROM, etc. Various functions, including a navigation function, are implemented by arithmetic processing performed by the CPU based on a predetermined program. The navigation apparatus 120 may be configured such that the touch panel serves as the operation part 122.

The navigation apparatus 120 is communicably connected to the object detection apparatus 100 and can transmit and receive various types of control signals to/from the object detection apparatus 100. The navigation apparatus 120 can receive, from the object detection apparatus 100, the captured images captured by the cameras 100a to 100x and the detection result detected by the object detection apparatus 100. The display 121 normally displays an image based on a function of only the navigation apparatus 120, under the control of the controller 123. However, when an operation mode is changed, an image, processed by the object detection apparatus 100, of surroundings of the vehicle is displayed on the display 121.

The object detection apparatus 100 includes an ECU (Electronic Control Unit) 10 that has a function of detecting an object and an image selector 30 that selects one from amongst the captured images captured by the multiple cameras 100a to 100x and that inputs the captured imaged selected to the ECU 10. The ECU 10 detects the object approaching the vehicle, based on one out of the captured images captured by the multiple cameras 100a to 100x. The ECU 10 is configured as a computer including a CPU, a RAM, a ROM, etc. Various control functions are implemented by arithmetic processing performed by the CPU based on a predetermined program.

A parameter selector 12 and an object detector 13 shown in the drawing are a part of the functions implemented by the arithmetic processing performed by the CPU in such a manner. A parameter memory 11 is materialized as a RAM, a ROM, a nonvolatile memory, etc. included in the ECU 10.

The parameter memory 11 retains a parameter to be used for a detection process of detecting the object approaching the vehicle, corresponding to each of multiple detection conditions. In other words, the parameter memory 11 retains the parameter for each of the multiple detection conditions.

For example, the parameters include information for specifying a camera that obtains a captured image that the object detector 13 uses for the detection process. Concrete examples of other parameters are described later.

The detection conditions include a traveling state of the vehicle on which the object detection system 1 is installed, presence/absence of an obstacle in the vicinity of the vehicle, a driving operation made by the user (driver) to the vehicle, a location of the vehicle, etc. Moreover, the detection conditions also include a situation in which the object detector 13 is expected to perform the detection process, i.e., a use state of the object detection system 1. The use state of the object detection system 1 is determined according to a combination of the traveling state of the vehicle, the presence/absence of an obstacle in a vicinity of the vehicle, the driving operation made by the user (driver) to the vehicle, the location of the vehicle, etc.

The parameter selector 12 selects a parameter that the object detector 13 uses for the detection process, from amongst the parameters retained in the parameter memory 11, corresponding to a detection condition at the time, out of the detection conditions.

The image selector 30 selects a captured image from amongst the captured images captured by the cameras 100a to 100x, as a captured image to be processed by the object detector 13, according to the parameter selected by the parameter selector 12. The object detector 13 performs the detection process of detecting the object approaching the vehicle, using the parameter selected by the parameter selector 12, based on the captured image selected by the image selector 30.

In this embodiment, the object detector 13 performs the detection process based on an optical flow indicating a movement of the object. The object detector 13 may detect the object approaching the vehicle based on object shape recognition using pattern matching.

In the aforementioned description, the information for specifying a camera is one of the parameters. However, a type of a camera that obtains the captured image to be used for the detection process may be one of the detection conditions. In this case, the parameter memory 11 retains a parameter for the detection process performed by the object detector 13, for each of the multiple cameras 100a to 100x.

Moreover, in this case, the image selector 30 selects, from amongst the multiple cameras 100a to 100x, a camera that obtains the captured image to be used for the detection process. The parameter selector 12 selects, from amongst the parameters retained in the parameter memory 11, a parameter that the object detector 13 uses for the detection process, according to the camera selected by the image selector 30.

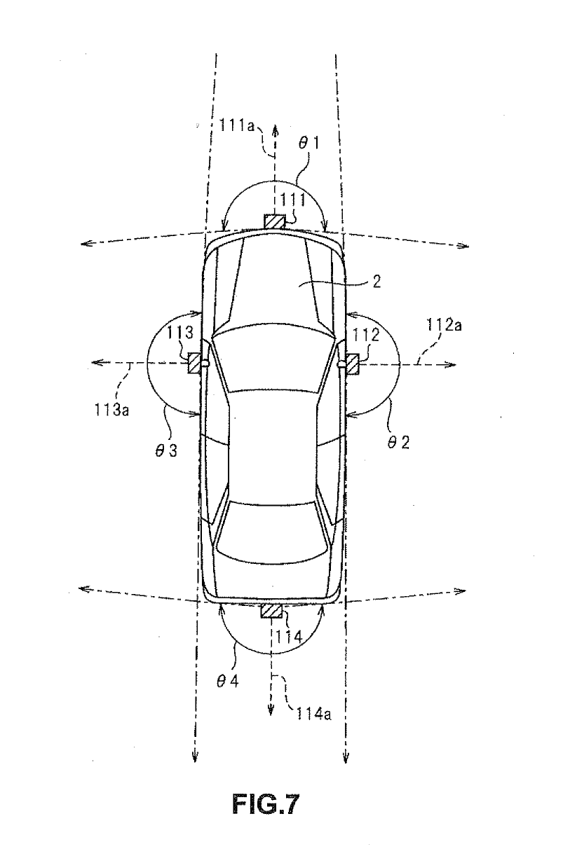

FIG. 7 illustrates an example of disposition of the multiple cameras. A front camera 111 is provided in the proximity of a license plate on a front end of a vehicle 2, having an optical axis 111a of the front camera 111 directed in a traveling direction of the vehicle 2. A rear camera 114 is provided in the proximity of a license plate on a rear end of the vehicle 2, having an optical axis 114a of the rear camera 114 directed in a direction opposite to the traveling direction of the vehicle 2. It is preferable that the front camera 111 or the rear camera 114 is installed substantially in a center between a left end and a light end of the vehicle 2. However, the front camera 111 or the rear camera 114 may be installed slightly left or right from the center.

A right-side camera 112 is provided on a side mirror on a right side of the vehicle 2, having an optical axis 112a of the right-side camera 112 directed in a right outward direction (a direction orthogonal to the traveling direction of the vehicle 2) of the vehicle 2. A left-side camera 113 is provided on a side mirror on a left side of the vehicle 2, having an optical axis 113a of the left-side camera 113 directed in a left outward direction (a direction orthogonal to the traveling direction of the vehicle 2) of the vehicle 2. Each angle of fields of view (FOV) θ1 to θ4 of the cameras 111 to 114 is approximately 180 degrees.

### 1-2. Concrete Example of Parameters

Next described are concrete examples of the parameters that the object detector 13 uses for the detection process.

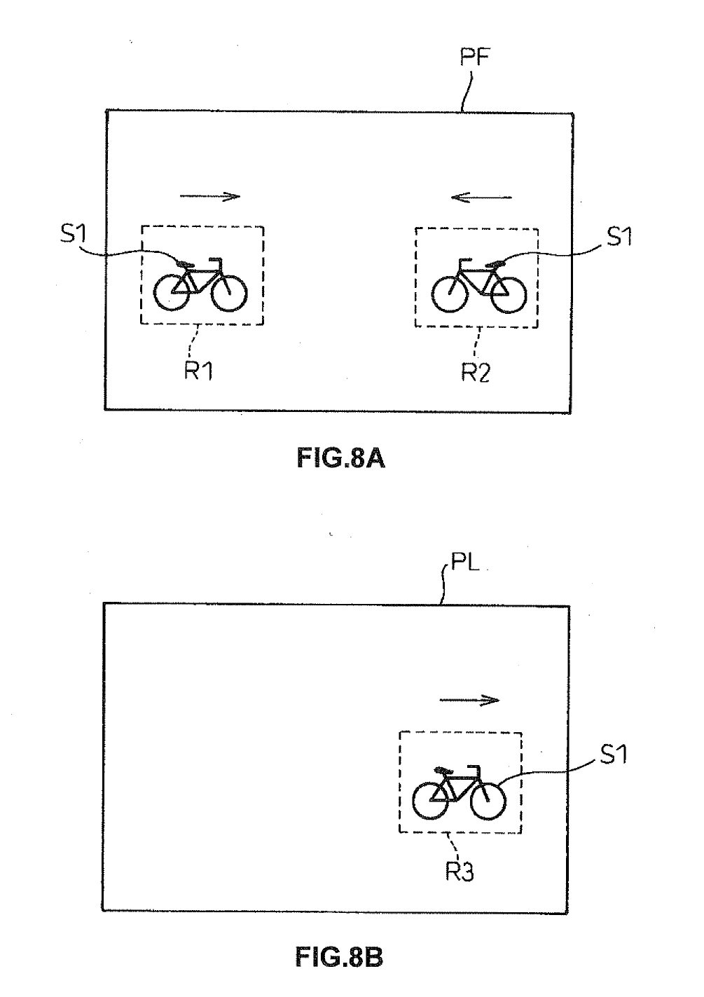

The parameters include, for example, a location of a detection range that is a region, on the captured image, to be used for the detection process. FIG. 8A illustrates detection ranges on a front camera image. FIG. 8B illustrates a detection range on a left camera image. As shown in FIG. 8A, when an object (two-wheel vehicle) S1 approaching from a side of the vehicle 2 is detected at an intersection with poor visibility, using the captured image captured by the front camera 111, a left region R1 and a right region R2 on a front camera image PF are used as the detection ranges.

On the other hand, as shown in FIG. 8B, when the object S1 is detected similarly using the captured image captured by the left-side camera 113, a right region R3 on a left camera image PL is used as the detection range. As described above, the detection range varies according to each of the detection conditions, for example, a camera, out of the multiple cameras, which captures an image to be used for the detection process.

Moreover, the parameters include an optical flow direction of an object to be determined to be approaching the vehicle. The parameters may include a range of length of the optical flow.

As shown in FIG. 8A, in a case of detecting the object S1 using the captured image captured by the front camera 111, it is determined that the object S1 is approaching the vehicle 2 if the optical flow of the object S1 moves from an end portion to a center portion in both of the left region R1 and the right region R2 on the front camera image PF. In the description below, the optical flow moving from the end portion of an image to the center portion of the image may be referred to as “inward flow.”

On the other hand, as shown in FIG. 8B, in a case of detecting the object S1 similarly using the captured image captured by the left-side camera 113, it is determined that the object S1 is approaching the vehicle 2 if the optical flow of the object S1 moves from the center portion to the end portion in the right region R3 on the left camera image PL. In the description below, the optical flow moving from the center portion of an image to the end portion of the image may be referred to as “outward flow.”

FIG. 8A and FIG. 8B explain the cases where the object (two-wheel vehicle) S1 approaching from the side of the vehicle 2 is detected at the intersection with poor-visibility. The parameter (the position of the detection range on the captured image or the optical flow direction of the object to be determined to be approaching the vehicle) also varies according to the use state of the object detection system 1.

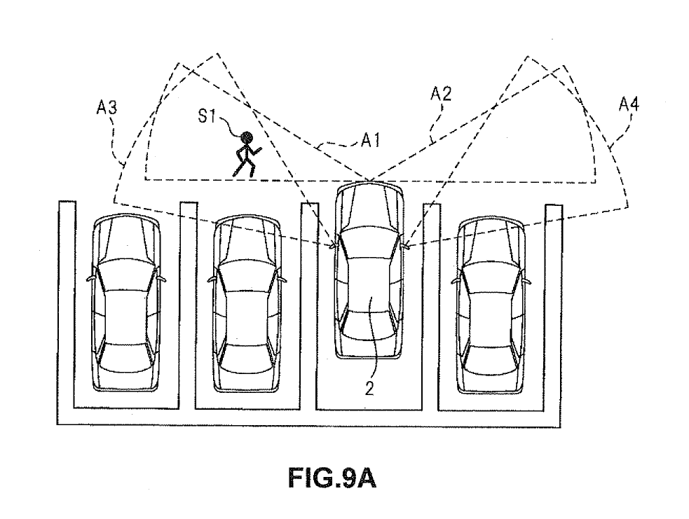

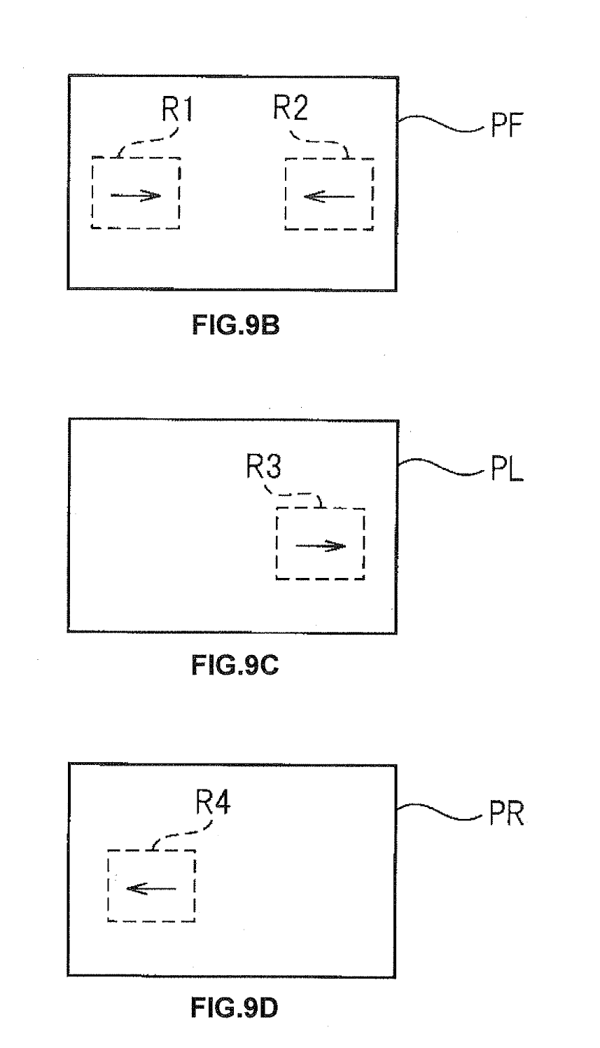

Referring to FIG. 9A, it is presumed that an object (a passerby) S1 approaching the vehicle 2 from a side thereof is detected when the vehicle 2 leaves a parking space. In the situation shown in FIG. 9A, there is a possibility that the approaching object S1 is present in each of ranges A1 and A2 of which images are captured by the front camera 111, of a range A3 of which image is captured by the left-side camera 113, and of a range A4 of which image captured by the right-side camera 112.

FIG. 9B, FIG. 9C and FIG. 9D illustrate the detection ranges, in the situation shown in FIG. 9A, respectively on the front camera image PF, the left camera image PL, and a right camera image PR. In this situation, the detection ranges to be used for the detection process are the left region R1 and the right region R2 on the front camera image PF, the right region R3 on the left camera image PL, and a left region R4 on the right camera image PR. Arrows shown on FIG. 9B to 9D indicate optical flow directions of objects to be determined to be approaching the vehicle 2. This applies to drawings referred to hereinafter.

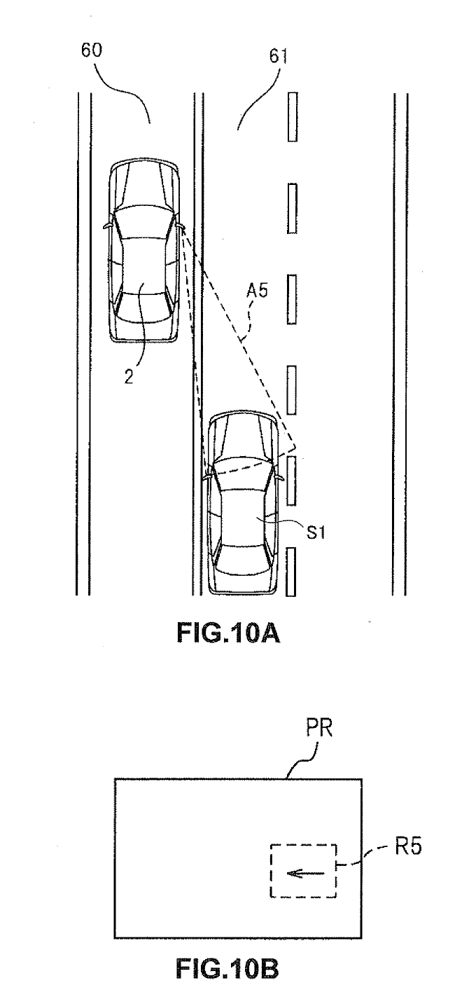

Referring to FIG. 10A, in a case of detecting an object (a vehicle) S1 approaching from behind on the right side of the vehicle 2 when the vehicle 2 changes lanes from a merging lane 60 to a driving lane 61. In this case, there is a possibility that the object S1 is present in a range A5 of which image is captured by the right-side camera 112.

FIG. 10B illustrates the detection range on the right camera image PR in the situation shown in FIG. 10A. In this situation, the detection range to be used for the detection process is a right region R5 on the right camera image PR. As is shown by a comparison between FIG. 9D and FIG. 10B, the position of the detection range on the right camera image PR and the optical flow direction of the object to be determined to be approaching the vehicle, vary according to the use state of the object detection system 1. In other words, the parameters to be used for the detection process vary according to the use state of the object detection system 1.

The parameters include a per-distance parameter corresponding to a distance of a target object to be detected. A detection method in the detection process of detecting an object at a relatively long distance is slightly different from a detection method in the detection process of detecting an object at a relatively short distance. Therefore, the per-distance parameters include a long-distance parameter to be used to detect the object at the long distance and a short-distance parameter to be used to detect the object at the short distance.

In a specific time period, a traveling distance of an object at the long distance is less than a traveling distance of an object at the short distance, on the captured image. Therefore, the per-distance parameters include, for example, the number of frames to be compared to detect a movement of the object. The number of frames for the long-distance parameter is greater than the number of frames for the short-distance parameter.

Moreover, the parameters may include types of the target object, such as person, vehicle, and two-wheel vehicle.

### 1-3. Object Detection Method

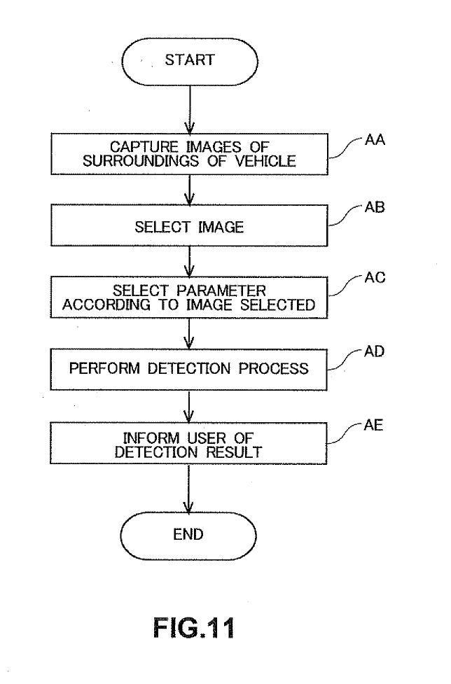

FIG. 11 illustrates an example of a process performed by the object detection system 1 in a first configuration example.

In a step AA, the multiple cameras 110a to 110x capture images of the surroundings of the vehicle 2.

In a step AB, the parameter selector 12 selects the information for specifying the cameras according to each of the detection conditions at the time. Accordingly, the parameter selector 12 selects a camera, from amongst the multiple cameras 110a to 110x, to obtain the captured image to be used for the detection process. Then, the image selector 30 selects the captured image captured by the camera selected, as a target image for the detection process.

In a step AC, the parameter selector 12 selects parameters other than the information for specifying the camera, according to the captured image selected by the image selector 30.

In a step AD, the object detector 13 performs the detection process of detecting an object approaching the vehicle based on the captured image selected by the image selector 30, using the parameters selected by the parameter selector 12.

In a step AE, the ECU 10 informs the user, via an HMI, of a detection result detected by the object detector 13.

According to this embodiment, the parameters each of which corresponds to each of the multiple detection conditions are prepared beforehand, and a parameter is selected from amongst the parameters prepared, corresponding to each of the detection conditions at the time, and then the parameter selected is used for the detection process of detecting the object approaching the vehicle. Thus, the detection process can be performed based on the parameter appropriate to the each detection condition at the time. As a result, detection accuracy can be improved.

For example, the detection accuracy is improved by performing the detection process using a camera, out of the multiple cameras, appropriate to the detection conditions at the time. Moreover, the detection accuracy is improved by performing the detection process using an appropriate parameter, out of the parameters, according to the captured'image to be processed.

### 2. Second Embodiment

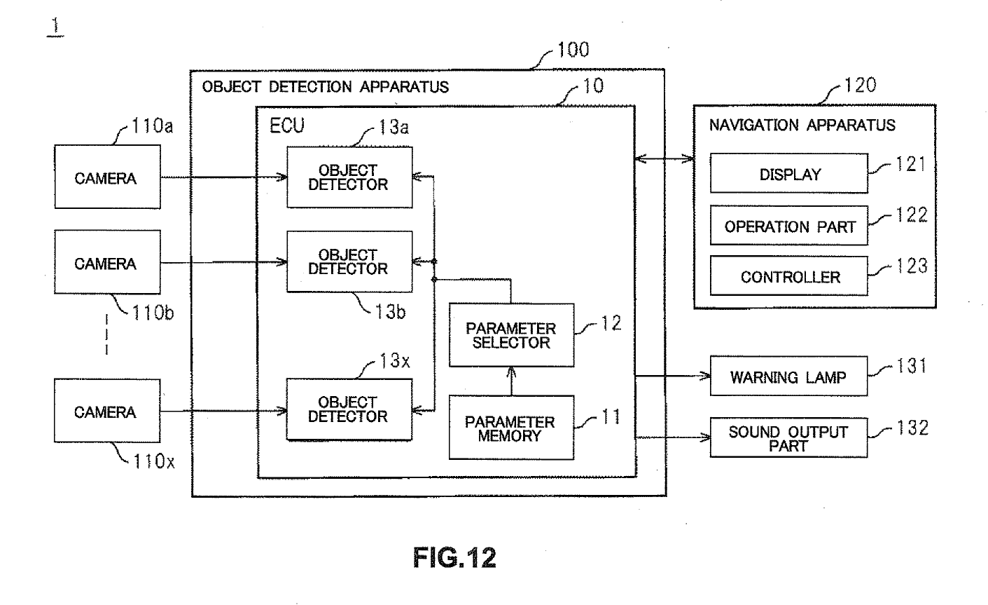

Next described is another embodiment of the object detection system 1. FIG. 12 is a block diagram illustrating a second configuration example of the object detection system 1. The same reference numerals are used to refer to the same structural elements as the structural elements described, referring to FIG. 6, in the first configuration example. Structural elements having the same reference numerals are the substantially same unless otherwise explained. Moreover, other embodiments may include structural elements and functions described below in the second configuration example.

An ECU 10 includes multiple object detectors 13a to 13x of which number is the same as the number of multiple cameras 110a to 110x. The object detectors 13a to 13x respectively correspond to the multiple cameras 110a to 110x. Each of the object detectors 13a to 13x performs the detection process based on a captured image captured by the corresponding camera. Functions of each of the object detectors 13a to 13x are the same as functions of the object detector 13 shown in FIG. 6. A parameter memory 11 retains parameters that the multiple object detectors 13a to 13x use for the detection process, for each of the multiple cameras 110a to 110x (in other words, for each of the multiple object detectors 13a to 13x).

A parameter selector 12 selects from the parameter memory 11 a parameter, from amongst the parameters, prepared to be used for the detection process based on the captured image captured by each of the multiple cameras 110a to 110x. The parameter selector 12 provides the parameter selected for each of the multiple cameras 110a to 110x to the corresponding object detector. When one of the multiple object detectors 13a to 13x detects an object approaching the vehicle, the ECU 10 informs the user, via an HMI, of a detection result.

The parameter selector 12 selects the parameter corresponding to each of the multiple object detectors 13a to 13x. The parameter selector 12 retrieves from the parameter memory 11 the parameter to be provided to each of the multiple object detectors 13a to 13x so that the multiple object detectors 13a to 13x can detect a same object. The parameters to be provided to the multiple object detectors 13a to 13x vary according to each camera of the multiple cameras respectively corresponding to the multiple object detectors 13a to 13x. Therefore, the parameter memory 11 retains the parameter corresponding to each of the multiple object detectors 13a to 13x such that the multiple object detectors 13a to 13x detect the same object.

For example, in the detection range R1 on the front camera image PF explained referring to FIG. 8A, the two-wheel vehicle S1 approaching the vehicle 2 from the side of the vehicle 2 is detected based on whether or not an inward optical flow is detected. On the other hand, in the detection range R3 on the left camera image PL explained referring to FIG. 8B, the same two-wheel vehicle S1 is detected based on whether or not an outward optical flow is detected.

According to this embodiment, since an object on captured images captured by the multiple cameras can be detected substantially simultaneously, the object approaching the vehicle can be detected earlier and more accurately.

Moreover, according to this embodiment, the parameter appropriate to the captured image captured by each camera of the multiple cameras can be provided to each of the multiple object detectors 13a to 13x to detect a same object based on the captured images captured by the multiple cameras. Thus, there is an increasing possibility that the same object can be detected by the multiple object detectors 13a to 13x, and the detection sensitivity is improved.

### 3. Third Embodiment

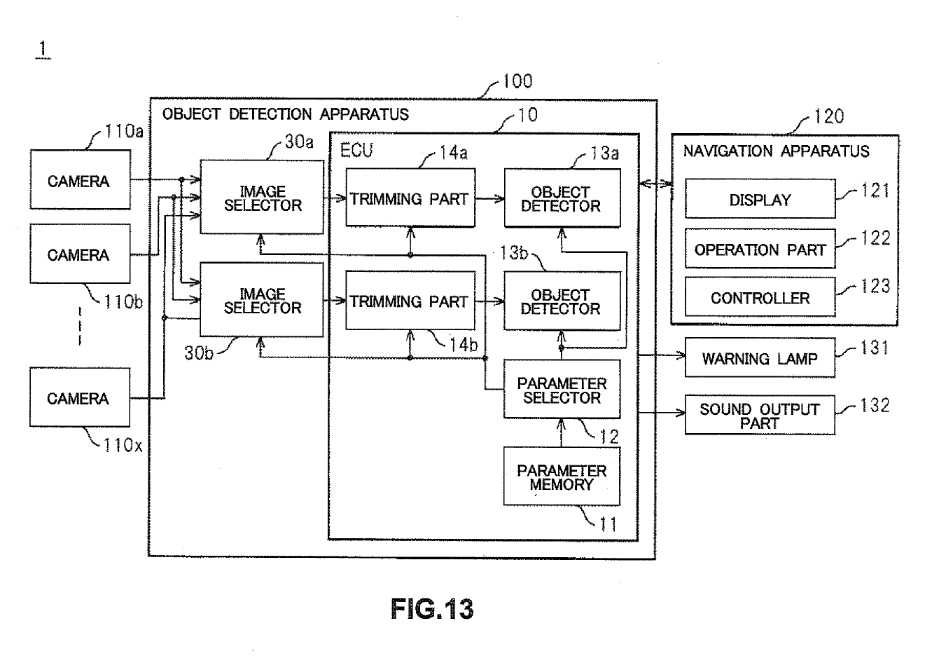

Next described is another embodiment of the object detection system 1. FIG. 13 is a block diagram illustrating a third configuration example of the object detection system 1. The same reference numerals are used to refer to the same structural elements as structural elements described, referring to FIG. 6, in a first configuration example. Structural elements having the same reference numerals are the substantially same unless otherwise explained. Moreover, another embodiment may include structural elements and functions described below in the third embodiment.

An object detection apparatus 100 in this configuration example includes two object detectors 13a and 13b, two image selectors 30a and 13b, and two trimming parts 14a and 14b fewer than the number of multiple cameras 110a to 110x. The two trimming parts 14a and 14b are implemented by arithmetic processing performed by a CPU of an ECU 10, based on a predetermined program.

The image selectors 30a and 30b correspond respectively to the object detectors 13a and 13b. Each of the image selectors 30a and 30b selects a captured image to be used for a detection process performed by the corresponding object detectors. Moreover, the two trimming part 14a and 14b correspond respectively to the two object detectors 13a and 13b. The trimming part 14a clips a partial region of the captured image selected by the image selector 30a, as a detection range that the object detector 13a uses for the detection process, and then inputs the captured image in the detection range to the object detector 13a. Similarly, the trimming part 14b clips a partial region of the captured image selected by the image selector 30b, as a detection range that the object detector 13b uses for the detection process, and then inputs the captured image in the detection region to the object detector 13b. Functions of the object detectors 13a and 13b are the substantially same as the object detectors 13 shown in FIG. 6. The two object detectors 13a and 13b function separately. Therefore, the two object detectors 13a and 13b are capable of performing the detection process respectively base on the detection ranges that are different from each other, respectively clipped by the trimming parts 14a and 14b and.

The object detection apparatus 100 in this embodiment includes two sets of a system having the image selector, the trimming part, and the object detector. However, the object detection apparatus 100 may include three or more sets of the system.

In this embodiment, the image selectors 30a and 30b select captured images based on parameters selected by a parameter selector 12. The trimming part 14a and 14b select the detection ranges on the captured images based on the parameters selected by the parameter selector 12. Moreover, the trimming part 14a and 14b input into the object detectors 13a and 13b the captured images clipped into the detection ranges selected.

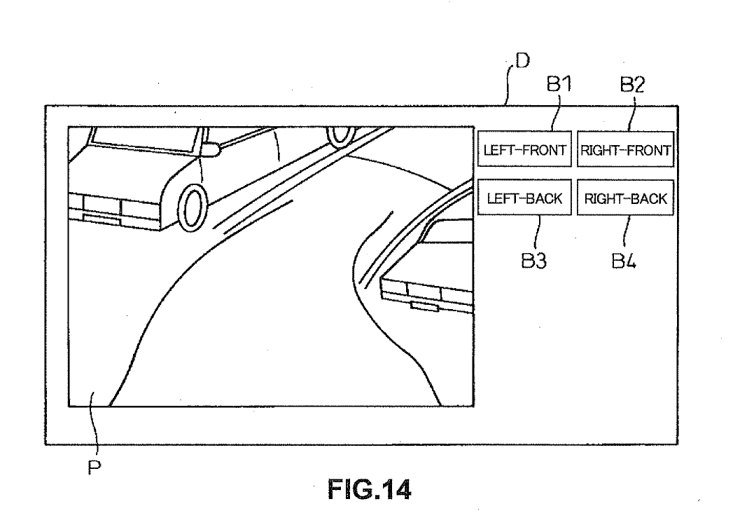

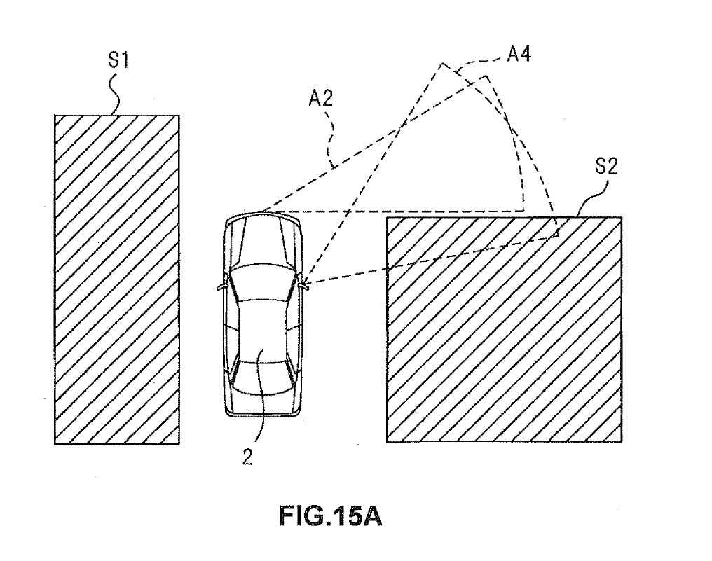

The captured images may be selected by the image selectors 30a and 30b in response to a user operation via an HMI, and also the detection ranges may be selected by the trimming parts 14a and 14B in response to a user operation via the HMI. In this case, the user can specify the captured images and the detection ranges, for example, by operating a touch panel provided to a display 121 of a navigation apparatus 120. FIG. 14 illustrates an example displayed on the display 121 of the navigation apparatus 120.

An image D is a display image displayed on the display 121. The display image D includes a captured image P captured by one of the multiple cameras 110a to 110x and also includes four operation buttons B1, B2, B3 and B4 implemented on the touch panel.

When the user presses the “left-front” button B1, the image selectors 30a and 30b and the trimming parts 14a and 14b select captured images and detection ranges appropriate for detecting an object approaching from ahead of a vehicle 2 on the left. When the user presses the “right-front” button B2, the image selectors 30a and 30b and the trimming parts 14a and 14b select captured images and detection ranges appropriate for detecting an object approaching from ahead of the vehicle 2 on the right.

When the user presses the “left-back” button B3, the image selectors 30a and 30b and the trimming parts 14a and 14b select captured images and detection ranges appropriate for detecting an object approaching from behind the vehicle 2 on the left. When the user presses the “right-back” button B4, the image selectors 30a and 30b and the trimming parts 14a and 14b select captured images and detection ranges appropriate for detecting an object approaching from behind the vehicle 2 on the right.

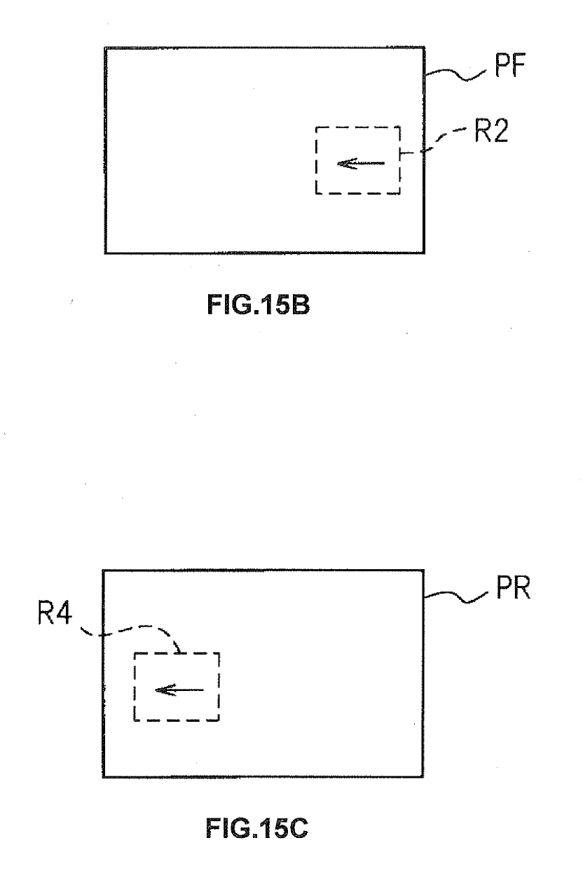

Usage examples of the operation buttons B1 to B4 are hereinafter described. When turning right on a narrow street as shown in FIG. 15A, the user presses the “right-front” button B2. In this case, a range A2 of which image is captured by a front camera 111 and a range A4 of which image is captured by a right-side camera 112 are target ranges in which an object is detected.

At this time, the image selectors 30a and 30b select a front camera image PF shown in FIG. 15B and a right camera image PR shown in FIG. 15C. And the two trimming parts 14a and 14b select a right region R2 on the front camera image PF and a left region R4 on the right camera image PR as the detection ranges.

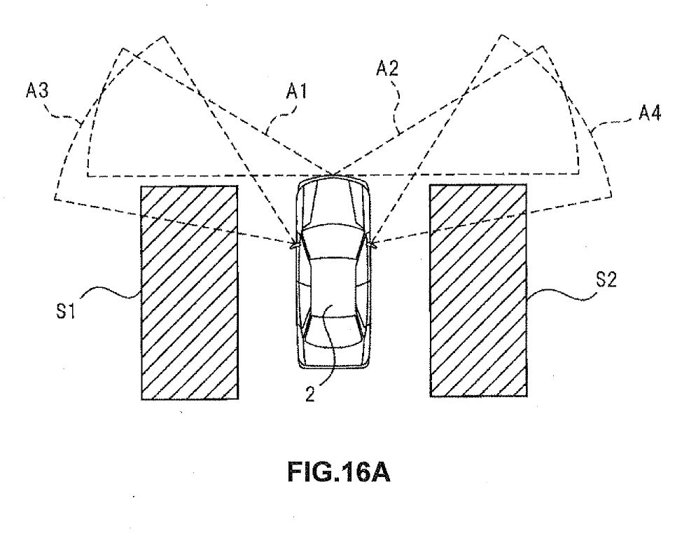

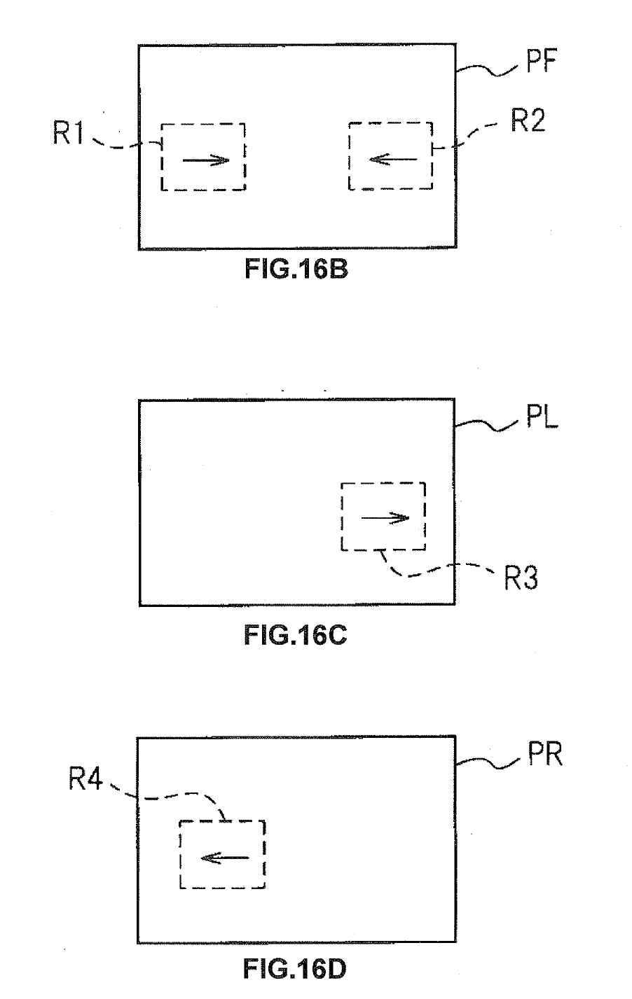

When leaving a parking space as shown in FIG. 16A, the user presses the “left-front” button B1 and the “right-front” button B2. In this case, a range A1 and the range A2 of which images are captured by the front camera 111 are the target ranges in which an object is detected. At this time both image selectors 30a and 30b select the front camera image PF shown in FIG. 16B. The two trimming parts 14a and 14b select a left region R1 on the front camera image PF and the right region R2 on the front camera image PF as the detection ranges.

Moreover, in this case, a range A3 of which image is captured by a left-side camera 113 and the range A4 of which image is captured by the right-side camera 112 may also be the target ranges in which an object is detected. In this case, the object detection apparatus 100 may include four or more sets of the system having the image selector, the trimming part, and the object detector in order to perform object detection in these four ranges A1, A2, A3, and A4 substantially simultaneously. In this case, the image selectors select the front camera image PF, a left camera image PL, and the right camera image PR shown in FIG. 16B to 16D. The trimming parts select the left region R1 and the right region R2 on the front camera image PF, a right region R3 on the left camera image PL, and the left region R4 on the right camera image PR as the detection ranges.

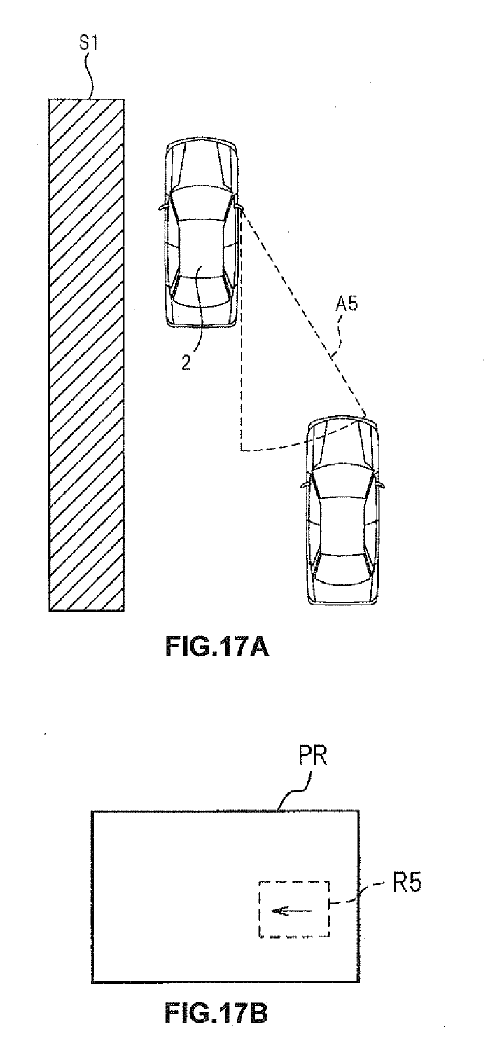

When changing lanes as shown in FIG. 17A, the user presses the “right-back” button B4. In this case, a range A5 of which image is captured by the right-side camera 112 is the target range in which an object is detected. One of the image selectors 30a and 30b selects the right camera image PR shown in FIG. 17B, and one of the trimming parts 14a and 14b selects a left region R5 on the right camera image PR as the detection range.

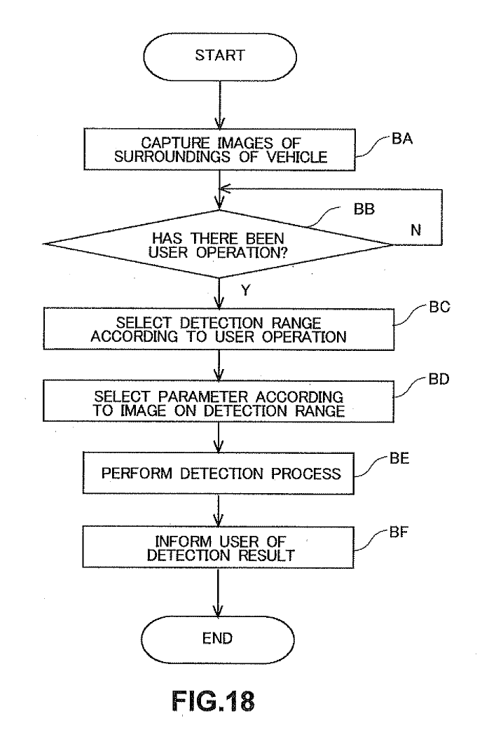

FIG. 18 illustrates the first example of a process performed by the object detection system 1 in a third configuration example.

In a step BA, the multiple cameras 110a to 110x capture images of surroundings of the vehicle 2. In a step BB, the navigation apparatus 120 determines whether or not there has been a user operation via the display 121 or via an operation part 122, to specify a detection range.

When there has been the user operation (Y in the step BB), the process moves to a step BC. When there has not been the user operation (N in the step BB), the process returns to the step BB.

In the step BC, the image selectors 30a and 30b and the trimming parts 14a and 14b select detection ranges to be input into the object detectors 13a and 13b, based on the user operation, and input the images in the detection ranges into the object detectors 13a and 13b. In a step BD, the parameter selector 12 selects parameters other than a parameter relating to specifying the detection ranges on the captured images, according to the images (images in the detection ranges) to be input into the object detectors 13a and 13b.

In a step BE, the object detectors 13a and 13b perform the detection process based on the images in the detection ranges selected by the image selectors 30a and 30b and the trimming parts 14a and 14b, using the parameters selected by the parameter selector 12. In a step BF, the ECU 10 informs the user of a detection result detected by the object detector 13 via the HMI.

According to this embodiment, inclusion of the multiple object detectors 13a and 13b allows the user to check safety by detecting an object in multiple target detection ranges substantially simultaneously, for example, when the user turns right as shown in FIG. 15A or when the user leaves a parking space as shown in FIG. 16A. Moreover, the multiple object detectors 13a and 13b perform the detection process based on different regions clipped by the trimming parts 14a and 14b. Thus, it is possible to perform the object detection of an object in different target detection ranges on one captured image and also the object detection of an object in target detection ranges on different captured images.

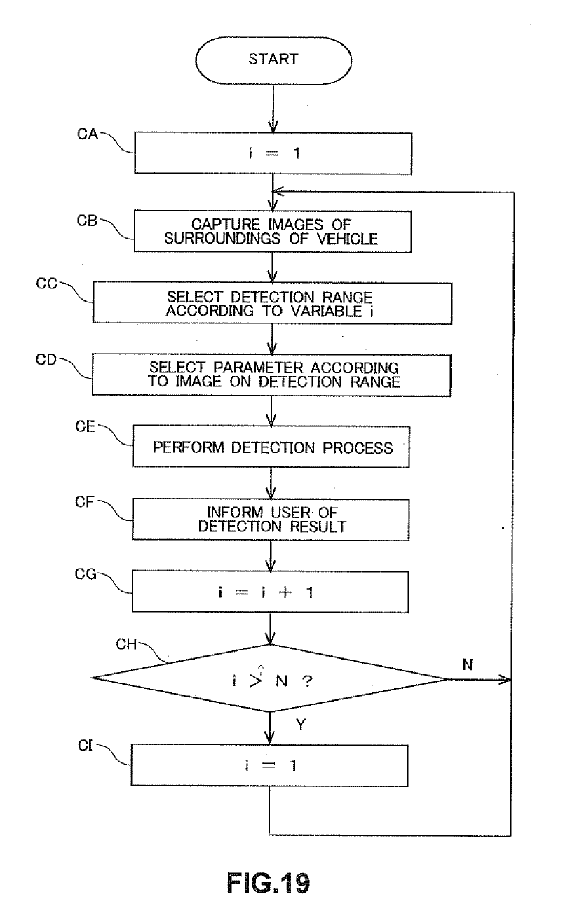

The object detection apparatus in this embodiment includes multiple sets of the system having the image selector, the trimming part, and the object detector. However, the object detection apparatus may include only one set of the system and may switch, by time sharing control, images in the detection ranges to be processed by the object detector. An example of such a processing method is shown in FIG. 19.

First, possible situations where the object detector performs the detection process are presumed beforehand, and a captured image and a detection range to be used for the detection process per possible situation are set for each of the possible situations. In other words, a captured image and a detection range to be selected by the image selector and the trimming part are determined beforehand. Here, it is assumed that M types of the detection ranges are set for a target situation.

In a step CA, the parameter selector 12 assigns a value “1” to a variable “i”. In a step CB, the multiple cameras 110a to 110x capture images of the surroundings of the vehicle 2.

In a step CC, the image selector and the trimming part select an ith detection range from amongst M types of the detection ranges set beforehand according to the target situation, then input an image in the detection range to the object detector 13. In a step CD, the parameter selector 12 selects parameters other than a parameter relating to specifying the detection range of the image, according to the captured image (the image in the detection range) to be input into the object detector 13 (objective image).

In a step CE, the object detector performs the detection process based on the image in the detected range selected by the image selector and the trimming part, according to the parameters selected by the parameter selector 12. In a step CF, the ECU 10 informs the user of a detection result detected by the object detector 13, via an HMI.

In a step CG, the parameter selector 12 increments the variable i by one. In a step CH, the parameter selector 12 determines whether or not the variable i is greater than M. When the variable i is greater than M (Y in the step CH), a value “1” is assigned to the variable i in a step CI and then the process returns to the step CB. When the variable i is equal to or less than M (N in the step CH), the process returns to the step CB. The image in the detection range to be input into the object detector is switched by time sharing control by repeating the aforementioned process from the step CB to the step CG.

### 4. Fourth Embodiment

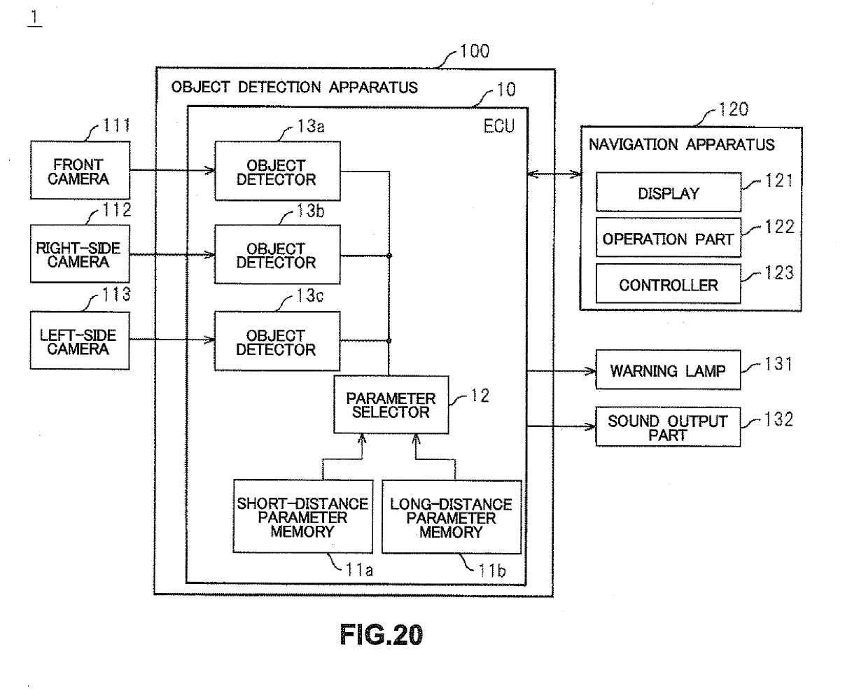

Next, another embodiment of the object detection system 1 is described. FIG. 20 is a block diagram illustrating a fourth configuration example of the object detection system 1. The same reference numerals are used to refer to the same structural elements as the structural elements described in the first configuration example described referring to FIG. 6. Structural elements having the same reference numerals are the substantially same unless otherwise explained. Moreover, other embodiments may include the structural elements and the functions described below in the fourth embodiment.

An ECU 10 includes multiple object detectors 13a to 13c and a short-distance parameter memory 11a and a long-distance parameter memory 11b. Moreover, the object detection system 1 includes a front camera 111, a right-side camera 112, and a left-side camera 113 as the multiple cameras 110a to 110x.

Object detectors 13a to 13c correspond respectively to the front camera 111, the right-side camera 112, and the left-side camera 113. Each of the object detectors 13a to 13c performs a detection process based on a captured image captured by the corresponding camera. Function of each of the object detectors 13a to 13c is the same as the function of the object detector 13 shown in FIG. 6.

The short-distance parameter memory 11a and the long-distance parameter memory 11b are implemented as a RAM, a ROM or a nonvolatile memory included in the ECU 10, and respectively retain a short-distance parameter and a long-distance parameter.

A parameter selector 12 selects the long-distance parameter for the object detector 13a that performs the detection process based on a captured image captured by the front camera 111. On the other hand, the parameter selector 12 selects the short-distance parameter for the object detector 13b that performs the detection process based on a captured image by the right-side camera 112 and for the object detector 13c that performs the detection process based on a captured image capture by the left-side camera 113.

Since being capable of seeing farther than the right-side camera 112 and the left-side camera 113, the front camera 111 is suitable to detect an object at a long distance. According to this embodiment, the captured image captured by the front camera 111 is used for detection of the object at the long distance, and the captured image capture by the right-side camera 112 or the left-side camera 113 is used particularly for detection of an object at a short distance. As a result, each of the cameras can supplement ranges that the other cameras cannot cover and detection accuracy can be improved in a case of detecting an object in a wide range.

### 5. Fifth Embodiment

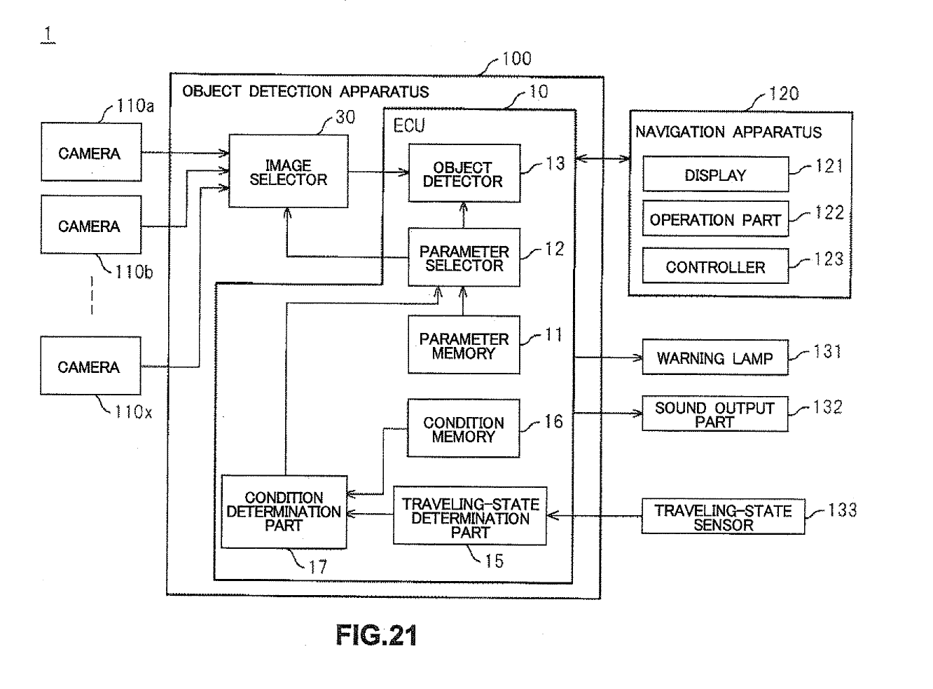

Next, another embodiment of the object detection system 1 is described. FIG. 21 is a block diagram illustrating a fifth configuration example of the object detection system 1. The same reference numerals are used to refer to the same structural elements as the structural elements described in the first configuration example described referring to FIG. 6. Structural elements having the same reference numerals are the substantially same unless otherwise explained.

Like the configuration shown in FIG. 13, an ECU 10 may include a trimming part that clips a partial region of a captured image selected by an image selector 30 as a detection range used for a detection process performed by an object detector 13, which is applicable to the following embodiment. Moreover, other embodiments may include the structural elements and the functions thereof described below in the fifth configuration example.

The object detection system 1 includes a traveling-state sensor 133 that detects a signal indicating a traveling state of a vehicle 2. The traveling-state sensor 133 includes a vehicle speed sensor that detects a speed of the vehicle 2 and a yaw rate sensor that detects a turning speed of the vehicle 2, etc. When the vehicle 2 already includes these sensors, these sensors are connected to the ECU 10 via a CAN (Control Area Network) of the vehicle 2.

The ECU 10 includes a traveling-state determination part 15, a condition memory 16, and a condition determination part 17. The traveling-state determination part 15 and the condition determination part 17 are implemented by arithmetic processing performed by a CPU of the ECU 10, based on a predetermined program. The condition memory 16 is implemented as a RAM, a ROM or a nonvolatile memory included in the ECU 10.

The traveling-state determination part 15 determines the traveling state of the vehicle 2 based on a signal transmitted from the traveling-state sensor 133. The condition memory 16 stores a predetermined condition which the condition determination part 17 uses to make a determination relating to the traveling state.

For example, the condition memory 16 stores a condition that “the speed of the vehicle 2 is 0 km/h.” Moreover, the condition memory 16 also stores a condition that “the speed of the vehicle 2 is greater than 0 km/h and less than 10 km/h.”

The condition determination part 17 determines whether or not the traveling state of the vehicle 2 determined by the traveling-state determination part 15 satisfies the predetermined condition stored in the condition memory 16. The condition determination part 17 inputs a determination result to a parameter selector 12.

The parameter selector 12 selects, according to the traveling state of the vehicle 2, a parameter that the object detector 13 uses for the detection process. Concretely, the parameter selector 12 selects, from amongst the parameters retained in a parameter memory 11, the parameter that the object detector 13 uses for the detection process, based on whether or not the traveling state of the vehicle 2 satisfies the predetermined condition stored in the condition memory 16.

For example, in a case where the condition memory 16 stores a condition that “the speed of the vehicle 2 is 0 km/h,” when the speed of the vehicle 2 is 0 km/h (in other words, when the vehicle is stopping), the parameter selector 12 selects a parameter such that the object detector 13 performs the detection process using a front camera image and a long-distance parameter.

Moreover, when the speed of the vehicle is not 0 km/h (in other words, when the vehicle is not stopping), the parameter selector 12 selects a parameter such that the object detector 13 performs the detection process using a right camera image, a left camera images and a short-distance parameter.

Moreover, for example, when the speed of the vehicle 2 is greater than 0 km/h and less than 10 km/h, the parameter selector 12 selects a parameter such that the object detector 13 performs the detection process using front, right, and left camera images.

In this case, the condition memory 16 stores a condition that “the speed of the vehicle 2 is greater than 0 km/h and less than 10 km/h.” When the speed of the vehicle 2 is greater than 0 km/h and less than 10 km/h, the parameter selector 12 selects a parameter such that the object detector 13 performs the detection process using the front camera image and the long-distance parameter, and a parameter such that the object detector 13 performs the detection process using the left and right camera images and the short-distance parameter. In addition the parameter selector 12 switches the selection of the parameters by time sharing control. Thus, the object detector 13 performs the detection processes by time sharing control, using the front camera image and the long-distance parameter, and the left and right camera images and the short-distance parameter.

Furthermore, as another example, in a case where the vehicle 2 changes lanes as shown in FIG. 10A, when the yaw rate sensor detects a turn of the vehicle 2, the parameter selector 12 selects a parameter that sets a right region R5 on a right camera image PR as a detection range.

In addition, in a case where the vehicle 2 leaves a parking space as shown in FIG. 9A, when the yaw rate sensor does not detect a turn of the vehicle 2, the parameter selector 12 selects a parameter that sets a left region R1 and a right region R2 on a front camera image PF shown in FIG. 9B, a right region R3 on a left camera image PL shown in FIG. 9C, and a left region R4 of the right camera image PR shown in FIG. 9D, as the detection ranges.

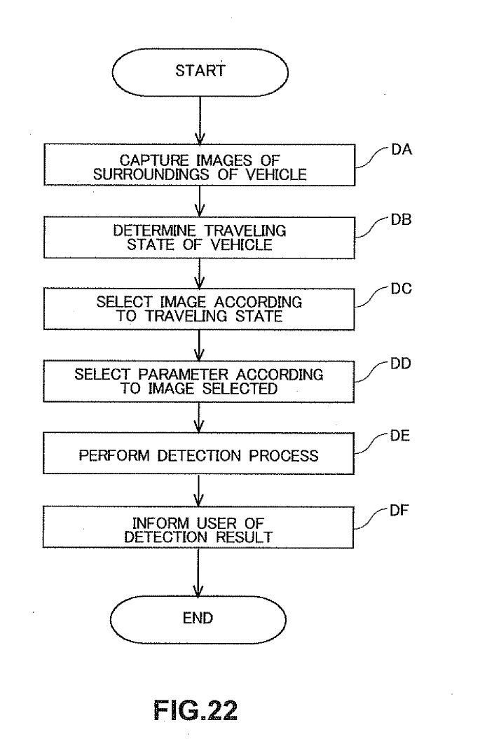

FIG. 22 illustrates an example of a process performed by the object detection system 1 in the fifth configuration example.

In a step DA, multiple cameras 110a to 110x capture images of surroundings of the vehicle 2. In a step DB, the traveling-state determination part 15 determines the traveling state of the vehicle 2.

In a step DC, the condition determination part 17 determines whether or not the traveling state of the vehicle 2 satisfies the predetermined condition stored in the condition memory 16. The parameter selector 12 selects a parameter that specifies an image (a captured image or an image in the detection range) to be input into the object detector 13 (objective image), based on whether or not the traveling state of the vehicle 2 satisfies the predetermined condition stored in the condition memory 16. The image specified is input into the object detector 13.

In a step DD, the parameter selector 12 selects parameters other than the parameter relating to specifying the objective image, according to the objective image (the captured image or the image in the detection range).

In a step DE, the object detector 13 performs the detection process based on the image input, using the parameters selected by the parameter selector 12. In a step DF, the ECU 10 informs the user of a detection result detected by the object detector 13, via an HMI.

According to this embodiment, the parameters that the object detector 13 uses for the detection process can be selected, according to the traveling state of the vehicle 2. Thus, the detection process of detecting an object can be performed using a parameter appropriate to the traveling state of the vehicle 2. As a result, accuracy of a detection condition is improved and safety also can be improved.

### 6. Sixth Embodiment

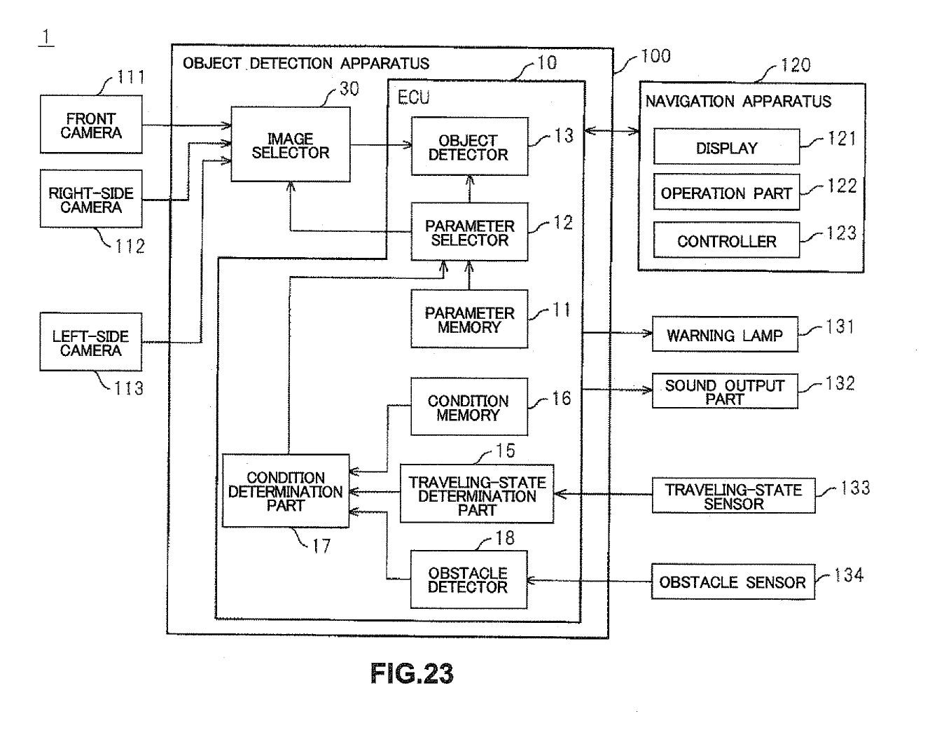

Next, another embodiment of the object detection system 1 is described. FIG. 23 is a block diagram illustrating a sixth configuration example of the object detection system 1. The same reference numerals are used to refer to the same structural elements as the structural elements described in the fifth configuration example described referring to FIG. 21. Structural elements having the same reference numerals are the substantially same unless otherwise explained. Moreover, other embodiments may include structural elements and functions thereof described below in the sixth configuration example.

The object detection system 1 includes a front camera 111, a right-side camera 112, and a left-side camera 113 as multiple cameras 110a to 110x. Moreover, the object detection system 1 includes an obstacle sensor 134 that detects an obstacle in a vicinity of a vehicle 2. The obstacle sensor 134 is, for example, an ultrasonic detecting and ranging sonar.

An ECU 10 includes an obstacle detector 18. The obstacle detector 18 is implemented by arithmetic processing performed by a CPU of the ECU 10, based on a predetermined program. The obstacle detector 18 detects an obstacle in the vicinity of the vehicle 2 according to a detection result detected by the obstacle sensor 134. The obstacle detector 18 may detect the obstacle in the vicinity of the vehicle 2 by a pattern recognition based on a captured image captured by one of the front camera 111, the right-side camera 112, and the left-side camera 113.

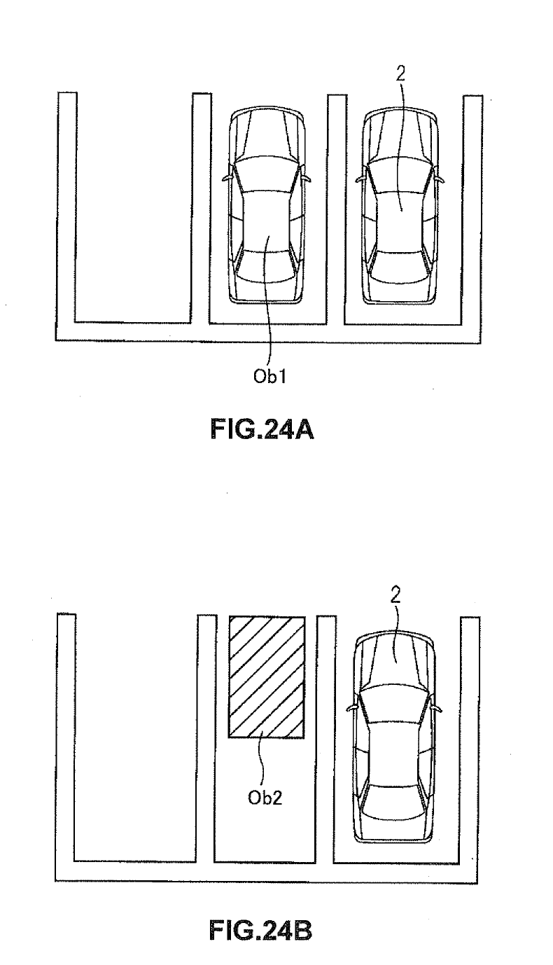

FIG. 24A and FIG. 24B illustrate examples of obstacles. In the example shown in FIG. 24A, a parked vehicle Ob1 next to the vehicle 2 blocks a FOV of the left-side camera 113. Moreover, in the example shown in FIG. 24V, a pillar Ob2 next to the vehicle 2 blocks the FOV of the left-side camera 113.

In such a case where an obstacle is detected in the vicinity of the vehicle 2, an object detector 13 performs a detection process based on a captured image captured by a camera, out of the multiple cameras, that faces a direction in which the obstacle is not present. For example, in the cases shown in FIG. 24A and FIG. 24B, the object detector 13 performs the detection process based on the captured image captured by the front camera 111 that faces a direction in which the obstacles Ob1 and Ob2 are not present. On the other hand, in a case where there is no such an obstacle, the object detector 13 performs the detection process based on the captured images captured by the left-side camera 113 in addition to the front camera 111.

FIG. 23 is here referred. A condition determination part 17 determines whether or not the obstacle detector 18 has detected an obstacle in the vicinity of the vehicle 2. Moreover, the condition determination part 17 determines whether or not a traveling state of the vehicle 2 satisfies a predetermined condition stored in a condition memory 16. The condition determination part 17 inputs a determination result to a parameter selector 12.

When the traveling state of the vehicle 2 satisfies the predetermined condition stored in the condition memory 16 and also when an obstacle is detected in the vicinity of the vehicle 2, the parameter selector 12 selects a parameter that sets only the captured image captured by the front camera 111 as an image to be input into the object detector 13 (objective image). On the other hand, when the traveling state of the vehicle 2 satisfies the predetermined condition stored in the condition memory 16 and also when no obstacle is detected in the vicinity of the vehicle 2, the parameter selector 12 selects a parameter that sets captured images captured by the right-side camera 112 and the left-side camera 113 in addition to a captured image captured by the front camera 111, as the objective images. In this case, the captured images captured by the multiple cameras 111, 112, and 113 are selected by an image selector 30, by time sharing control, and are input into the object detector 13.

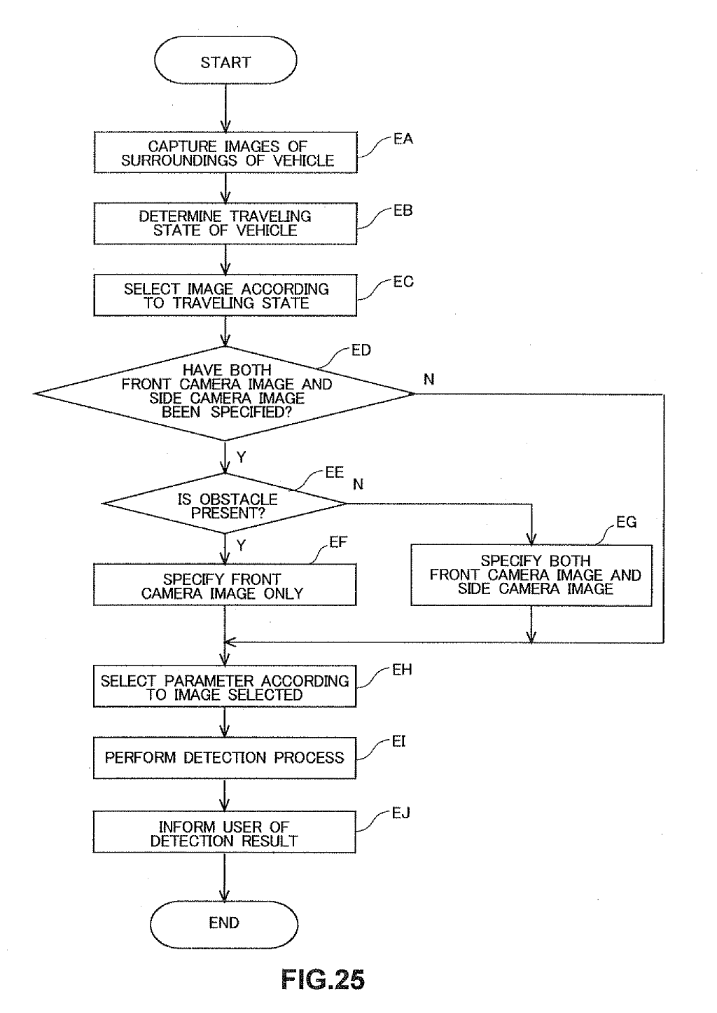

FIG. 25 illustrates an example of a process performed by the object detection system 1 in the sixth configuration example.

In a step EA, the front camera 111, the right-side camera 112 and the left-side camera 113 capture images of surroundings of the vehicle 2. In a step EB, the traveling-state determination part 15 determines the traveling state of the vehicle 2.

In a step EC, the condition determination part 17 determines whether or not the traveling state of the vehicle 2 satisfies the predetermined condition stored in the condition memory 16. The parameter selector 12 selects the parameter that specifies the objective image, based on whether or not the traveling state of the vehicle 2 satisfies the predetermined condition stored in the condition memory 16.

In a step ED, the parameter selector 12 determined whether or not both a front camera image and a side-camera image have been specified in the step EC. When both the front camera image and the side-camera image have been specified (Y in the step ED), the process moves to a step EE. When one of the front camera image and the side-camera image has not been specified in the step EC (N in the step ED), the process moves to a step EH.

In the step EE, the condition determination part 17 determines whether or not an obstacle has been detected in the vicinity of the vehicle 2. When an obstacle has been detected (Y in the step EE), the process moves to a step EF. When an obstacle has not been detected (N in the step EE), the process moves to a step EG.

In the step EF, the parameter selector 12 selects a parameter that specifies only the front camera image as the objective image. The image specified is selected by the image selector 30. Then the process moves to the step EH.

In the step EG, the parameter selector 12 selects a parameter that specifies the right and the left camera images in addition to the front camera image as the objective images. The images specified are selected by the image selector 30. Then the process moves to the step EH.

In the step EH, the parameter selector 12 selects parameters other than the parameter relating to specifying the objective image, according to the objective image.

In a step EI, the object detector 13 performs the detection process based on the image input, using the parameters selected by the parameter selector 12. In a step EJ, the ECU 10 informs the user of a detection result detected by the object detector 13, via an HMI.

According to this embodiment, when the object detection cannot be performed because one of the right-side and the left-side cameras is blocked by an obstacle in the vicinity of the vehicle 2, the object detection by the side camera blocked can be omitted. Thus, a useless detection process performed by the object detector 13 can be reduced.

Moreover, when the captured images captured by multiple cameras are switched and are input into the object detector 13, by time sharing control, the omission of process the captured image captured by the side camera of which field of view is blocked by an obstacle, allows the other cameras to perform the object detection for a longer time. Thus, safety is improved.

In this embodiment, a target object to be detected is an obstacle that is present on one of a right side and a left side of a host vehicle, and at least one camera is selected from amongst the side cameras and the front camera, according to a detection result. However, the target object and the camera to be selected are not limited to the examples of this embodiment. In other words, when a FOV of a camera is blocked by an obstacle, an object may be detected based on a captured image captured by a camera, out of the multiple cameras, that faces a direction in which the obstacle is not present.

### 7. Seventh Embodiment

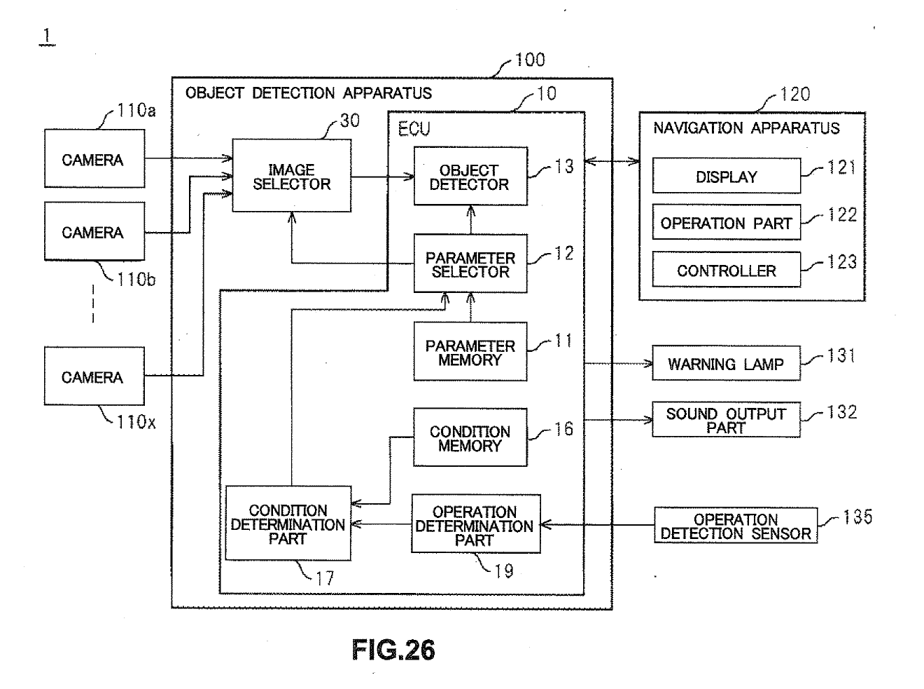

Next, another embodiment of the object detection system 1 is described. FIG. 26 is a block diagram illustrating a seventh configuration example of the object detection system 1. The same reference numerals are used to refer to the same structural elements as the structural elements described in the first configuration example described referring to FIG. 6. Structural elements having the same reference numerals are the substantially same unless otherwise explained. Moreover, other embodiments may include the structural elements and the functions thereof described below in the seventh configuration example.

The object detection system 1 includes an operation detection sensor 135 that detects a driving operation made by a user to a vehicle 2. The operation detection sensor 135 includes a turn signal lamp switch, a shift sensor that detects a position of a shift lever, a steering angle sensor, etc. Since the vehicle 2 already includes these sensors, these sensors are connected to an ECU 10 via a CAN (Control Area Network) of the vehicle 2.

The ECU 10 includes a condition memory 16, a condition determination part 17, and an operation determination part 19. The condition determination part 17 and the operation determination part 19 are implemented by arithmetic processing performed by a CPU of the ECU 10, based on a predetermined program. The condition memory 16 is implemented as a RAM, a ROM or a nonvolatile memory included in the ECU 10.

The operation determination part 19 obtains information, from the operation detection sensor 135, on the driving operation made by the user to the vehicle 2. The operation determination part 19 determines a content of the driving operation made by the user. The operation determination part 19 determines the content of the driving operation such as a type of the driving operation and an amount of the driving operation. More concretely, examples of the content of the driving operation are, for example, turn-on or turn-off of the turn signal lamp switch, a position of the shift lever, and an amount of a steering operation. The condition memory 16 stores a predetermined condition which the condition determination part 17 uses to determine the content of the driving operation.

For example, the condition memory 16 stores conditions, such as that “a turn signal lamp is ON,” “the shift lever is in a position D (drive),” “the shift lever has been moved from a position P (parking) to the position D (drive),” and “the steering is turned to the right at an angle of 30 degrees or more.”

The condition determination part 17 determines whether or not the driving operation determined by the operation determination part 19, made to the vehicle 2, satisfies the predetermined condition stored in the condition memory 16. The condition determination part 17 inputs a determination result to a parameter selector 12.

The parameter selector 12 selects, according to whether or not the driving operation made to the vehicle 2 satisfies the predetermined condition stored in the condition memory 16, a parameter that an object detector 13 uses for a detection process, from amongst the parameters retained in a parameter memory 11.

For example, in a case where the vehicle 2 leaves a parking space as shown in FIG. 9A, when a change of a shift lever position to the position D is detected, the parameter selector 12 selects a parameter that sets a left region R1 and a right region R2 on a front camera image PF shown in FIG. 9B, a right region R3 on a left camera image PL shown in FIG. 9C, and a left region R4 on a right camera image PR shown in FIG. 9D, as detection ranges.

In a case where the vehicle 2 changes lanes as shown in FIG. 10A, when a right turn signal lamp is turned on, the parameter selector 12 selects a parameter that sets a right region R5 on the right camera image PR shown in FIG. 10B, as a detection range.

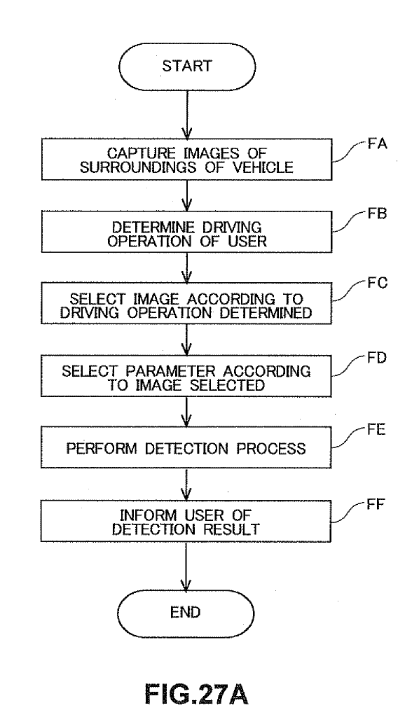

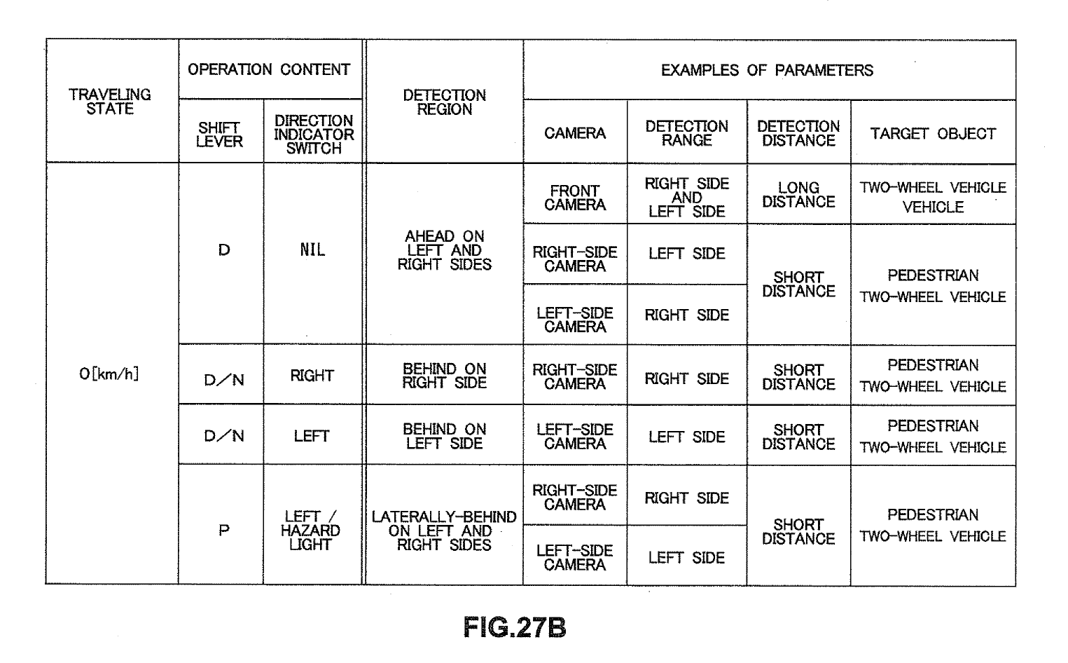

FIG. 27A illustrates an example of a process performed by the object detection system 1 in the seventh configuration example.

In a step FA, multiple cameras 110a to 110x capture images of surroundings of the vehicle 2. In a step FB, the operation determination part 19 determines the content of the driving operation made by the user.

In a step FC, the condition determination part 17 determines whether or not the driving operation made to the vehicle 2 satisfies the predetermined condition stored in the condition memory 16. The parameter selector 12 selects a parameter that specifies an image to be input into the object detector 13 (objective image), based on whether or not the driving operation made to the vehicle 2 satisfies the predetermined condition stored in the condition memory 16.

In a step FD, the parameter selector 12 selects parameters other than the parameter relating to specifying the objective image, according to the objective image.

In a step FE, the object detector 13 performs the detection process based on the image input, using the parameters selected by the parameter selector 12. In a step FF, the ECU 10 informs the user of a detection result detected by the object detector 13, via an HMI.

The object detection system 1 in other embodiments may include a traveling-state sensor 133 and a traveling-state determination part 15 shown in FIG. 21. The condition determination part 17 determines whether or not the content of the driving operation and the traveling state satisfy the predetermined condition. In other words, the condition determination part 17 determines whether or not a combination of the predetermined condition relating to the content of the driving operation and the predetermined condition relating to the traveling state is satisfied. The parameter selector 12 selects a parameter that the object detector 13 uses for the detection process, according to a determination result determined by the condition determination part 17.

FIG. 27B illustrates choice examples of the parameters according to the combination of the traveling state and the content of the driving operation. In this embodiment, a speed of the vehicle 2 is used as a condition relating to the traveling state. Moreover, as conditions relating to the content of the driving operation, a position of the shift lever and turn-on and turn-off of the turn signal lamp are used.

The parameters to be selected are: a captured image captured by a camera out of the multiple cameras, to be used; a position of the detection range on each captured image; a per-distance parameter; and a type of a target object to be detected.

When the speed of the vehicle 2 is 0 km/h, having the shift lever positioned in the position D and having the turn signal lamp OFF, object detection is performed for the right and left regions ahead of the vehicle 2. In this case, the front camera image PF, the right camera image PR, and the left camera image PL are used for the detection process. Moreover, the left region R1 and the right region R2 on the front camera image PF, the right region R3 on the left camera image PL, and the left region R4 on the right camera image PR are selected as the detection ranges.

A long-distance parameter appropriate to detection of a two-wheel vehicle and a vehicle is selected as the per-distance parameter of the front camera image PF. A short-distance parameter appropriate to detection of a pedestrian and a two-wheel vehicle is selected as the per-distance parameter for the right camera image PR and the left camera image PL.

When the speed of the vehicle 2 is 0 km/h, having the shift lever positioned in the position D or a position N (neutral), and having the right turn signal lamp ON, the object detection is performed for a right region behind the vehicle 2. In this case, the right camera image PR is used for the detection process. Moreover, the right region R5 on the right camera image PR is selected as the detection range. The short-distance parameter appropriate to the detection of a pedestrian and a two-wheel vehicle is selected as the per-distance parameter for the right camera image PR.

When the speed of the vehicle 2 is 0 km/h, having the shift lever positioned in the position D or the position N (neutral), having with a left turn signal lamp ON, the object detection is performed for a left region behind the vehicle 2. In this case, the left camera image PL is used for the detection process. Moreover, a left region on the left camera image PL is selected as the detection range. The short-distance parameter appropriate to the detection of a pedestrian and a two-wheel vehicle is selected as the per-distance parameter for the left camera image PL.

When the speed of the vehicle 2 is 0 km/h, with the shift lever positioned in the position P (parking), and with the left turn signal lamp or a hazard light ON, the object detection is performed for the left and right regions laterally behind the vehicle 2. In this case, the right camera image PR and the left camera image PL are used for the detection process.

Moreover, the right region R5 on the right camera image PR and the left region on the left camera image PL are selected as the detection ranges. The short-distance parameter appropriate to the detection of a pedestrian and a two-wheel vehicle is selected as the per-distance parameter for the right camera image PR and the left camera image PL.

According to this embodiment, the parameters that the object detector 13 uses for the detection process can be selected according to the driving operation made by the user to the vehicle 2. Thus, the object detection can be performed using a parameter appropriate to the state of the vehicle 2 presumed from the content of the driving operation to the vehicle 2. As a result, detection accuracy is improved and safety also can be improved.

### 8. Eighth Embodiment

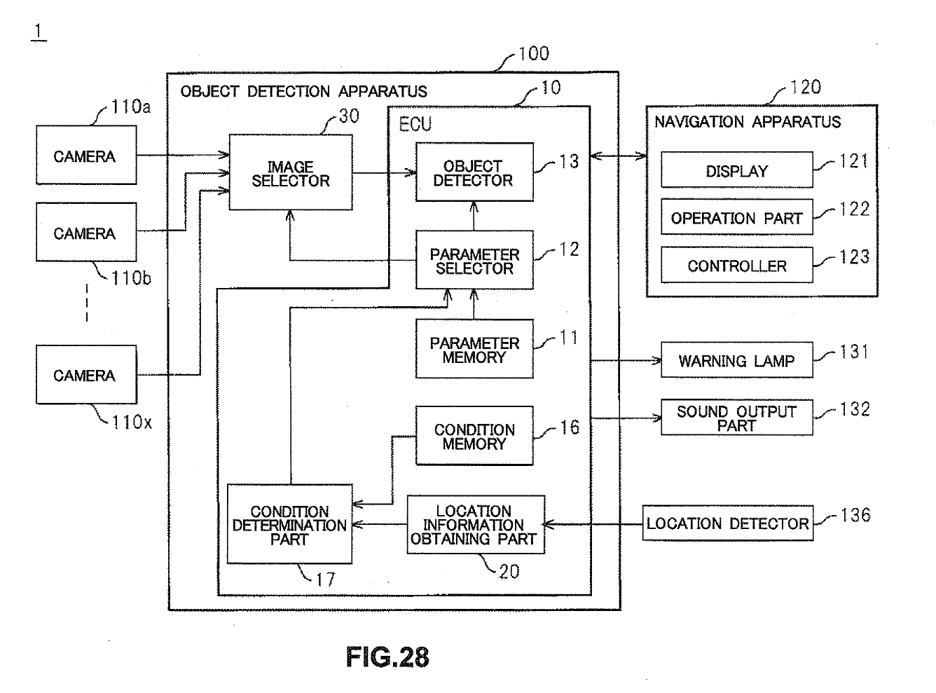

Next, another embodiment of the object detection system 1 is described. FIG. 28 is a block diagram illustrating an eighth configuration example of the object detection system 1. The same reference numerals are used to refer to the same structural elements as the structural elements described in the first configuration example described referring to FIG. 6. Structural elements having the same reference numerals are the substantially same unless otherwise explained.

The object detection system 1 includes a location detector 136 that detects a location of the vehicle 2. For example, the location detector 136 is a same structural element as a navigation apparatus 120. Moreover, the location detector 136 may be a driving safety support systems (DSSS) that can obtain location information of a vehicle 2, using road-to-vehicle communication.

An ECU 10 includes a condition memory 16, a condition determination part 17, and a location information obtaining part 20. The condition determination part 17 and the location information obtaining part 20 are implemented by arithmetic processing performed by a CPU of the ECU 10, based on a predetermined program. The condition memory 16 is implemented as a RAM, a ROM or a nonvolatile memory included in the ECU 10.

The location information obtaining part 20 obtains the location information on a location, detected by the location detector 136, of the vehicle 2. The condition memory 16 stores a predetermined condition that the condition determination part 17 uses for determination on the location information.

The condition determination part 17 determines whether or not the location information obtained by the location information obtaining part 20 satisfies the predetermined condition stored in the condition memory 16. The condition determination part 17 inputs a determination result to a parameter selector 12.

The parameter selector 12 selects a parameter that an object detector 13 uses for a detection process, from amongst the parameters retained in a parameter memory 11, according to whether or not the location of the vehicle 2 satisfies the predetermined condition stored in the condition memory 16.

For example, when the vehicle 2 as shown in FIG. 9A is located at a parking space, the parameter selector 12 selects a parameter that sets a left region R1 and a right region R2 on a front camera image PF in FIG. 9B, a right region R3 on a left camera image PL in FIG. 9C, and a left region R4 on a right camera image PR in FIG. 9D, as detection ranges.

Moreover, in a case where the vehicle 2 as shown in FIG. 10A changes lanes, when the vehicle 2 is located on a freeway or a merging lane of a freeway, the parameter selector 12 selects a parameter that sets a right region R5 on the right camera image PR as a detection range.

The object detection system 1 in other embodiments may include a traveling-state sensor 133 and a traveling-state determination part 15 shown in FIG. 21. Moreover, in replace of or in addition to the traveling-state sensor 133 and the traveling-state determination part 15, the object detection system 1 may include an operation detection sensor 135 and an operation determination part 19 shown in FIG. 26.

The condition determination part 17 determines whether or not, besides the location information, a content of a driving operation and/or a traveling state of the vehicle 2 satisfy(ies) the predetermined condition. In other words, the condition determination part 17 determines whether or not a combination of the predetermined condition relating to the location information, the predetermined condition relating to the content of the driving operation, and/or the predetermined condition relating to the traveling state is satisfied. The parameter selector 12 selects a parameter that the object detector 13 uses for the detection process, according to a determination result determined by the condition determination part 17.

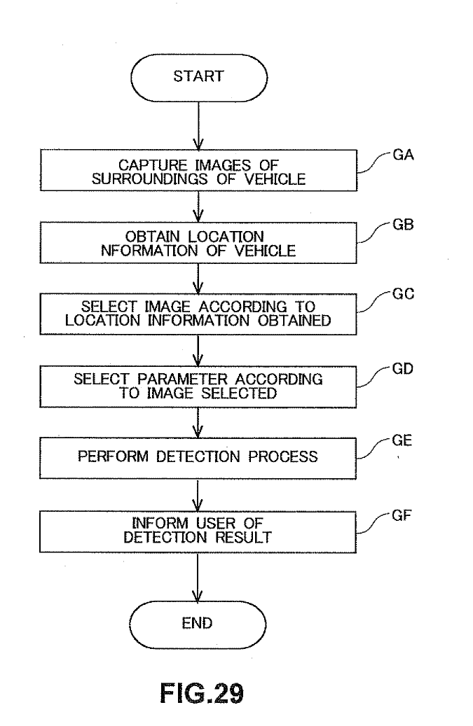

FIG. 29 illustrates a first example of a process performed by the object detection system 1 in the eighth configuration example.

In a step GA, multiple cameras 110a to 110x capture images of surroundings of the vehicle 2. In a step GB, the location information obtaining part 20 obtains the location information of the vehicle 2.

In a step GC, the condition determination part 17 determines whether or not the location information of the vehicle 2 satisfies the predetermined condition stored in the condition memory 16. The parameter selector 12 selects a parameter that specifies an image to be input into the object detector 13 (objective image), based on whether or not the location information of the vehicle 2 satisfies the predetermined condition stored in the condition memory 16. The image specified is input into the object detector 13.

In a step GD, the parameter selector 12 selects parameters other than the parameter relating to specifying the objective image, according to the objective image.

In a step GE, the object detector 13 performs the detection process based on the image input, using the parameters selected by the parameter selector 12. In a step GF, the ECU 10 informs a user of a detection result detected by the object detector 13, via an HMI.

In a case where a parameter that the object detector 13 uses for the detection process is selected based on a combination of the predetermined condition relating to the location information and the predetermined condition relating to the content of the driving operation, it may be determined that a determination result of the location information is used or that the content of the driving operation is used, for the detection process, according to accuracy of the location information of the vehicle 2.

In other words, when the location information of the vehicle 2 is more accurate than predetermined accuracy, the parameter selector 12 selects a parameter based on the location information of the vehicle 2 obtained by the location information obtaining part 20. On the other hand, when the location information of the vehicle 2 is less accurate than the predetermined accuracy, the parameter selector 12 selects a parameter based on the content of the driving operation made to the vehicle 2 determined by the operation determination part 19.

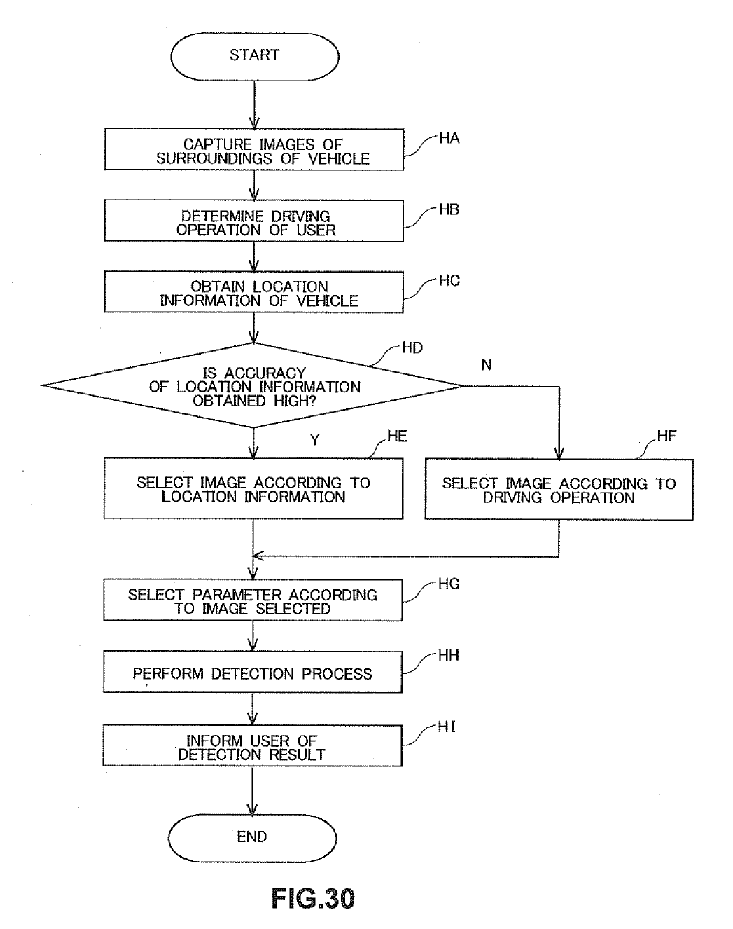

FIG. 30 illustrates a second example of a process performed by the object detection system 1 in the eighth configuration example.

In a step HA, multiple cameras 110a to 110x capture images of the surroundings of the vehicle 2. In a step HB, the operation determination part 19 determines the content of the driving operation made by the user. In a step HC, the location information obtaining part 20 obtains the location information of the vehicle 2.

In a step HD, the condition determination part 17 determines whether or not the location information of the vehicle 2 is more accurate than the predetermined accuracy. Instead of the determination described above, the location information obtaining part 20 may determine a level of accuracy of the location information. When a level of the location information accuracy is higher than the predetermined accuracy (Y in the step HD), the process moves to a step HE. When the level of the location information accuracy is not higher than the predetermined accuracy (N in the step HD), the process moves to a step HF.

In the step HE, the condition determination part 17 determines whether or not the location information of the vehicle 2 satisfies the predetermined condition stored in the condition memory 16. The parameter selector 12 selects a parameter that specifies an objective image, based on whether or not the location information of the vehicle 2 satisfies the predetermined condition stored in the condition memory 16. Then the process moves to a step HG.

In the step HF, the condition determination part 17 determines whether or not the driving operation made to the vehicle 2 satisfies the predetermined condition stored in the condition memory 16. The parameter selector 12 selects a parameter that specifies an objective image, based on whether or not the driving operation made to the vehicle 2 satisfies the predetermined condition stored in the condition memory 16. Then the process moves to the step HG.

In the step HG, the parameter selector 12 selects parameters other than the parameter relating to specifying the objective image, according to the image input into the object detector 13. In a step HH, the object detector 13 performs the detection process based on the image input, using the parameters selected by the parameter selector 12. In a step HI, the ECU 10 informs the user of a detection result detected by the object detector 13, via an HMI.

According to this embodiment, the parameters that the object detector 13 uses for the detection process can be selected based on the location information of the vehicle 2. Thus, object detection can be performed using the parameters appropriate to the state of the vehicle 2 presumed from the location information of the vehicle 2. As a result, detection accuracy is improved and safety also can be improved.

Next described is an informing method of a detection result via an HMI. A driver can be informed of the detection result via sound, voice guidance, display superimposed on a captured image captured by a camera. In a case where the detection result is superimposed to display on a captured image captured by a camera, display of all the captured images captured by multiple cameras used for detection of an object causes a problem that each of the captured images captured by the cameras is too small to easily understand the situation shown in each of the captured images. Moreover, another problem is that because there are too many captured images to check, the driver takes time to find a captured image to be focused on, which causes the driver to recognize a danger belatedly.

Therefore, in this embodiment, the captured image captured by one camera out of the multiple cameras is displayed on a display 121 and the captured images captured by the other cameras are superimposed on the captured image captured by the one camera.

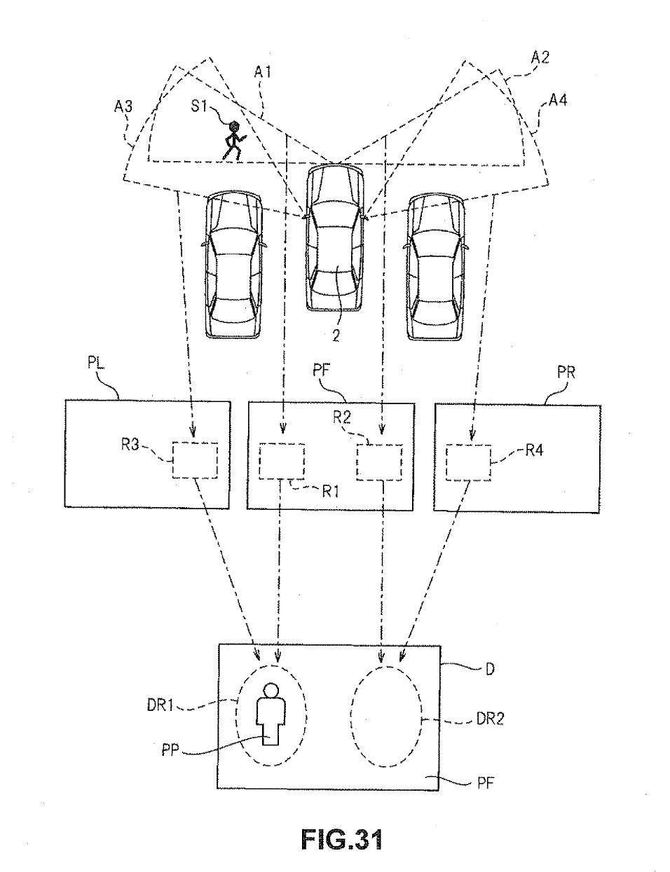

FIG. 31 illustrates an example of informing method of the detection result. In this example, target detection ranges in which an approaching object S1 is detected are a range A1 and a range A2 captured by a front camera 111, a range A4 captured by a right-side camera 112, and a range A3 captured by a left-side camera 113.

In this case, the left region R1 and the right region R2 on the front camera image PF, the right region R3 on the left camera image PL, and the left region R4 on the right camera image PR are used as the detection ranges.

In this embodiment, the front camera image PF is displayed as a display image D on the display 121. When the object S1 is detected in one of the left region R1 on the front camera image PF and the right region R3 on the left camera image PL, information indicating that the object S1 has been detected is displayed on a left region DR1 of the display image D. The information indicating that the object S1 is detected may be an image PP of the object S1 extracted from a captured image captured by a camera, text information for warning, a warning icon, etc.

On the other hand, when the object, S1 is detected in one of the right region R2 of the front camera image PF and the left region R4 of the right camera image PR, the information indicating that the object S1 has been detected is displayed on a right region DR2 of the display image D.

According to this embodiment, the user can look at a detection result on a captured image captured by a camera without awareness of the camera that captures the object. Therefore, the above-mentioned problem that captured images captured by multiple cameras are too small to be easily recognized on a display can be solved.

While the invention has been shown and described in detail, the foregoing description is in all aspects illustrative and not restrictive. It is therefore understood that numerous other modifications and variations can be devised without departing from the scope of the invention.

What is claimed is:

1. An object detection apparatus that detects an object in a vicinity of a vehicle, the object detection apparatus comprising:
a memory that retains a plurality of parameters used for a detection process of detecting an object making a specific movement relative to the vehicle, for each of a plurality of detection conditions;
a parameter selector that selects a parameter from amongst the parameters retained in the memory, according to an existing detection condition; and
an object detector that performs the detection process, using the parameter selected by the parameter selector, based on a captured image captured by a camera out of a plurality of cameras disposed at different locations of the vehicle.

2. The object detection apparatus according to claim 1, wherein
the parameter selector selects the parameter based on the camera which obtains the captured image that the object detector uses for the detection process.

3. The object detection apparatus according to claim 1, further comprising
a plurality of the object detectors, and wherein
the parameter selector selects the parameters corresponding to the plurality of object detectors.

4. The object detection apparatus according to claim 3, wherein
the plurality of object detectors respectively correspond to the plurality of cameras and perform the detection process based on the captured images captured by the corresponding cameras.

5. The object detection apparatus according to claim 3, further comprising:
a trimming part that clips a partial region of the captured image captured by one camera out of the plurality of cameras, and wherein
the plurality of object detectors perform the detection process based on different regions clipped by the trimming part.

6. The object detection apparatus according to claim 1, wherein
the plurality of cameras include:
a front camera facing forward from the vehicle; and
a side camera facing laterally from the vehicle, and wherein
the parameter selector selects:
a first parameter used to detect an object at a relatively long distance for the detection process based on the captured image captured by the front camera; and
a second parameter used to detect an object at a relatively short distance for the detection process based on the captured image captured by the side camera.

7. The object detection apparatus according to claim 1, further comprising
a traveling state detector that detects a traveling state of the vehicle, and wherein
the parameter selector selects the parameter according to the traveling state detected by the traveling state detector.

8. The object detection apparatus according to claim 7, wherein
the plurality of cameras include:
a front camera facing forward from the vehicle; and
a side camera facing laterally from the vehicle, and wherein
the object detector performs the detection process:
based on the captured image captured by the front camera when the vehicle is determined to be stopping based on the traveling state detected by the traveling state detector; and
based on the captured image captured by the side camera when the vehicle is determined to be traveling based on the traveling state detected by the traveling state detector.

9. The object detection apparatus according to claim 7, wherein
the plurality of cameras include:
a front camera facing forward from the vehicle; and
a side camera facing laterally from the vehicle, and wherein
the object detector performs, by time sharing control, the detection process based on the captured image captured by the front camera and the detection process based on the captured image captured by the side camera, when it is determined that a speed of the vehicle is greater than a first value and less than a second value, based on the traveling state detected by the traveling state detector.

10. The object detection apparatus according to claim 1, further comprising
an obstacle detector that detects an obstacle in the vicinity of the vehicle, and wherein
the object detector performs the detection process based on the captured image captured by a camera, from amongst the plurality of cameras, facing a direction where the obstacle is not present, when the obstacle detector detects the obstacle.

11. The object detection apparatus according to claim 1, further comprising
an operation determination part that determines a driving operation made by a user of the vehicle, and wherein
the parameter selector selects the parameter according to the driving operation determined by the operation determination part.

12. The object detection apparatus according to claim 1, further comprising
a location detector that detects a location of the vehicle, and wherein
the parameter selector selects the parameter according to the location of the vehicle detected by the location detector.

13. The object detection apparatus according to claim 1, wherein
the object detector performs the detection process based on an optical flow indicating a movement of the object.

14. An object detection method of detecting an object in a vicinity of a vehicle, the object detection method comprising the steps of
(a) selecting a parameter corresponding to a present detection condition, from amongst parameters prepared for each of a plurality of detection conditions and used for a detection process of detecting an object making a specific movement relative to the vehicle; and
(b) performing the detection process based on a captured image captured by a camera out of a plurality of cameras disposed at different locations of the vehicle, using the parameter selected in the step (a).

15. The object detection method according to claim 14, wherein
the step (a) selects the parameter based on the camera which obtains the captured image that the step (b) uses for the detection process.

16. The object detection method according to claim 14, wherein
the plurality of cameras include:
a front camera facing forward from the vehicle; and
a side camera facing laterally from the vehicle, and wherein
the step (a) selects:
a first parameter used to detect an object at a relatively long distance for the detection process based on the captured image captured by the front camera; and
a second parameter used to detect an object at a relatively short distance for the detection process based on the captured image captured by the side camera.

17. The object detection method according to claim 14, wherein
the step (b) performs the detection process based on an optical flow indicating a movement of the object.
